(19) United States
(12) Patent Application Publication
(10) Pub. No.: US 2017/0287041 A1
(43) Pub. Date: Oct. 5, 2017

(54) INFORMATION PROCESSING APPARATUS, INFORMATION PROCESSING METHOD, AND INFORMATION PROCESSING PROGRAM

(71) Applicant: Rakuten, Inc., Tokyo (JP)

(72) Inventor: Jinyong KIM, Tokyo (JP)

(73) Assignee: Rakuten, Inc., Tokyo (JP)

(21) Appl. No.: 15/315,224

(22) PCT Filed: Oct. 9, 2015
(86) PCT No.: PCT/JP2015/078788

§ 371 Date: Nov. 30, 2016

(51) Int. Cl. G06Q 30/06; G06F 17/30

(52) U.S. Cl. CPC G06Q 30/0625; G06F 17/30637; G06Q 30/0633; G06F 17/30675; G06F 17/30696; G06F 17/30867

(57) ABSTRACT

An information processing apparatus retrieves related search criteria that are related to given search criteria, from a search criteria history storage. The information processing apparatus retrieves first search results matching the related search criteria. The information processing apparatus retrieves second search results matching the given search criteria. The information processing apparatus identifies selection criteria, based on operation logs corresponding to the related search criteria. Based on a comparison between third search results and fourth search results, the information processing apparatus generates distinction information that indicates a distinction of the fourth search results. The third search results are among the first search results and identified based on the operation logs. The fourth search results are among the second search results and correspond to the selection criteria. The information processing apparatus provides the distinction information.

### TECHNICAL FIELD

The present invention relates to techniques, including systems, for providing search criteria that are related to search criteria given by a user.

### BACKGROUND ART

A system provides a user with search criteria that are related to search criteria given by the user in order to assist the user in retrieving search results based on the provided search criteria, which is conventionally known. For example, Patent Literature 1 discloses that a word of interest that is currently of interest as a search word in accordance with an instruction from an input unit and a plurality of related words belonging to a field related to the word of interest are displayed and that subclass related words for search keywords selected from among the word or interest and the related words are displayed.

### CITATION LIST

### Patent Literature

Patent Literature 1: JP H09-044525 A

### SUMMARY OF INVENTION

### Technical Problem

There may be cases where related search criteria that are related to search criteria newly specified by a user were previously specified by the user. The user may have seen search results retrieved when specifying the related search criteria and then have performed some operation on information, in the search results, that matched some criteria that the user was considering. However, with such a conventional art as described in Patent Literature 1, it is difficult for a user to see a difference between search results retrieved based on related search criteria previously specified by the user and search results retrieved based on search criteria newly specified by the user, under criteria that the user has been considering. Thus, it is not easy for the user to determine whether the newly specified search criteria are suitable search criteria for the user.

In view of the above point, it is an object of the present invention to provide an information processing apparatus and an information processing method that enable a user to easily see a difference between search results retrieved based on related search criteria previously specified and search results retrieved based on search criteria given later, under criteria that the user is considering.

### Solution to Problem

To solve the above problem, the invention according to claim 1 includes given search criteria obtaining means, related search criteria retrieval means, first search results retrieval means, second search results retrieval means, operation log retrieval means, selection criteria identifying means, generating means, and providing means. The given search criteria obtaining means obtains given search criteria given by a user. Search criteria history storage means stores a history of search criteria previously specified by the user. The related search criteria retrieval means retrieves, as related search criteria, search criteria related to the obtained given search criteria, from the search criteria history storage means. Search object storage means stores search objects. The first search results retrieval means retrieves first search results including search objects matching the retrieved related search criteria, from the search object storage means. The second search results retrieval means retrieves second search results including search objects matching the obtained given search criteria, from the search object storage means. Operation history storage means stores search criteria previously specified by the user and operation logs on search objects included in search results retrieved based on the search criteria in association with each other. The operation log retrieval means retrieves operation logs corresponding to the retrieved related search criteria, from the operation history storage means. Based on the retrieved operation logs, the selection criteria identifying means identifies selection criteria. Third search results are among the retrieved first search results and identified based on the retrieved operation logs. Fourth search results are among the retrieved second search results and match the identified selection criteria. Based on a comparison between the third search results and the fourth search results, the generating means generates distinction information that indicates a distinction of the fourth search results. The providing means provides the generated distinction information.

According to this invention, the information processing apparatus identifies selection criteria based on operation logs corresponding to related search criteria that are search criteria previously specified by a user. Among first search results retrieved based on the related search criteria, third search results are identified based on the operation logs. Among second search results retrieved based on given search criteria, fourth search results corresponding to the selection criteria are identified. Based on a comparison between the third search results and the fourth search results, the information processing apparatus generates distinction information that indicates a distinction of the fourth search results. The information processing apparatus provides the generated distinction information. In accordance with some criteria, the user operates a search object from among search results. Thus, the operated search criteria is highly likely to match criteria that the user has been considering. Among the first search results, third search criteria are likely to match criteria that the user has been considering. Among the second search results, fourth search criteria match the selection criteria that are likely to be the criteria that the user has been considering. Based on a comparison between the third search criteria and the fourth search criteria, distinction information is generated. Thus, by referring to the distinction information, the user can easily see a difference between search results retrieved based on related search criteria previously specified and search results retrieved based on search criteria given later, under criteria that the user is considering.

The invention according to claim 2 is the information processing apparatus according to claim 1 in which the search object storage means stores, for each of the search objects, a plurality of attribute values associated one-to-one with a plurality of attribute categories, and the operation log retrieval means retrieves display logs of attribute values of each of the search objects included in the first search results. The information processing apparatus further includes display attribute category identifying means. The display attribute category identifying means identifies attribute category(ies) that are among the plurality of attribute categories and that correspond to displayed attribute value(s), based on the retrieved display logs. The generating means includes, in the distinction information, attribute value(s) that are among attribute values corresponding to the fourth search results and that correspond to the attribute category(ies) identified by the display attribute category identifying means. Thus, the information processing apparatus can provide, as a distinction of second comparison search results, an attribute value of an attribute category in which a user is likely to be interested.

According to this invention, when an attribute value of a search object among search results was displayed, the information processing apparatus identifies the attribute category corresponding to the attribute value. The information processing apparatus then generates distinction information including an attribute value that is among attribute values corresponding to second search results and that corresponds to the identified attribute category. The attribute category corresponding to an attribute value viewed by a user is an attribute category in which the user is likely to be interested. Displaying distinction information including an attribute value corresponding to such an attribute category enables a user to easily see a difference between first search results and second search results, in an attribute in which the user is interested.

The invention according to claim 3 is the information processing apparatus according to claim 2 in which the generating means determines an attribute category that is among the identified attribute category(ies) and in which a variation among displayed attribute values of a plurality of search objects is less than or equal to a predetermined value, to be an attribute category of an attribute value included in the distinction information.

A user who is interested in an attribute category is likely to set an attribute value range corresponding to the attribute category to search for search objects. Thus, the user is highly likely to be interested in an attribute category in which the variation among displayed attribute values of a plurality of search objects is less than or equal to a predetermined value. This invention enables the information processing apparatus to more correctly identify an attribute category in which a user is likely to be interested.

The invention according to claim 4 is the information processing apparatus according to claim 2 in which the search object storage means stores, for each of the search objects, a plurality of attribute values associated one-to-one with a plurality of attribute categories. The information processing apparatus further includes criteria attribute category identifying means. If it is determined based on attribute values stored in the search object storage means that the given search criteria correspond to at least one attribute category of the plurality of attribute categories, the criteria attribute category identifying means identifies the at least one attribute category. The generating means includes, in the distinction information, an attribute value that is among attribute values corresponding to the fourth search results and that corresponds to the identified attribute category.

According to this invention, if it determines based on stored attribute values that given search criteria correspond to at least one attribute category, the information processing apparatus includes, in distinction information, an attribute value that is among second search results and that corresponds to the attribute category. A user sometimes includes, in given search criteria, an attribute value that the user desires for an attribute category in which the user is interested. This invention enables the information processing apparatus to provide, as a distinction of fourth search results, an attribute value corresponding to an attribute category in which a user is interested.

The invention according to claim 5 is the information processing apparatus according to any one of claims 1 to 4 in which the first search results retrieval means retrieves the first search results from which a display rank of each of search results included in the first search results can be identified, and the second search results retrieval means retrieves the second search results from which a display rank of each of search results included in the second search results can be identified. The information processing apparatus further includes rank identifying means. Operation history storage means stores user's operation logs. The rank identifying means retrieves, from the operation history storage means, user's operation logs on search results retrieved from the search object storage means based on search criteria previously specified by the user. Based on the retrieved operation logs, the rank identifying means identifies the display ranks of search results to be viewed by the user. The generating means generates the distinction information, based on a comparison between search results having the identified display ranks, among the third search results, and search results having the identified display ranks, among the fourth search results.

According to this invention, search results that are among third search results and that have the display ranks of search results to be viewed by the user are compared with search results that are among fourth search results and that have the display ranks of search results to be viewed by the user. Based on this comparison, the information processing apparatus generates distinction information. The sets of search results, which the user is likely to view, are thus compared. Consequently, the information processing apparatus can provide distinction information more appropriate for the user.

The invention according to claim 6 is the information processing apparatus according to any one of claims 1 to 5 in which the information processing apparatus further includes first relationship obtaining means and second relationship obtaining means. The first relationship obtaining means obtains a second relationship of each search result included among the first search results to the retrieved related search criteria. The second relationship obtaining means obtains a first relationship of each search result included among the second search results to the obtained given search criteria. The generating means generates the distinction information indicating a distinction of a search result that is included among both the third and fourth search results and of which the obtained second relationship is higher than the obtained first relationship.

According to this invention, the information processing apparatus generates distinction information that indicates a distinction of search results that are included among both third and fourth search results and whose relationships to given search criteria are higher than their relationships to related search criteria. Among search results included among both the third and fourth search results, there may be search results whose relationships to the given search criteria are different from their relationships to the related search criteria. Search results that are more highly related to the given search criteria than to the related search criteria are likely to have a distinction of the fourth search results relative to the third search results. This invention enables the information processing apparatus to provide a distinction of search results that are among the fourth search results and more highly related to the given search criteria.

The invention according to claim 7 is the information processing apparatus according to any one of claims 1 to 6 in which the search object storage means stores, for each of the search objects, a plurality of attribute values associated one-to-one with a plurality of attribute categories. The information processing apparatus further includes attribute category identifying means. The attribute category identifying means identifies an attribute category that is among the plurality of attribute categories and in which a difference between an attribute value of search results included among third search results and an attribute value of search results included among fourth search results satisfies a predetermined condition. The generating means includes, in the distinction information, an attribute value that is among attribute values included in the fourth search results and that corresponds to the identified attribute category.

According to this invention, the information processing apparatus generates distinction information including an attribute value that is among attribute values corresponding to fourth search results and that corresponds to an attribute category in which the difference in attribute values between the third search results and the fourth search results satisfies a predetermined condition. An attribute category in which the difference in the attribute values satisfies a predetermined condition is likely to indicate a distinctive attribute of the fourth search results relative to the third search results. This invention enables the information processing apparatus to provide a distinctive attribute of fourth search results relative to third search results.

The invention according to claim 8 is an information processing method performed by a computer. The method includes the following steps. Given search criteria given by a user are obtained. Search criteria history storage means stores a history of search criteria previously specified by the user. Search criteria related to the obtained given search criteria are retrieved as related search criteria, from the search criteria history storage means. Search object storage means stores search objects. First search results including search objects matching the retrieved related search criteria are retrieved from the search object storage means. Second search results including search objects matching the obtained given search criteria are retrieved from the search object storage means. Operation history storage means stores search criteria previously specified by the user and operation logs on search objects included in search results retrieved based on the search criteria in association with each other. Operation logs corresponding to the retrieved related search criteria are retrieved from the operation history storage means. Based on the retrieved operation logs, selection criteria are identified. Third search results are among the retrieved first search results and identified based on the retrieved operation logs. Fourth search results are among the retrieved second search results and match the identified selection criteria. Based on a comparison between the third search results and the fourth search results, distinction information indicating a distinction of fourth search results is generated. The generated distinction information is provided.

The invention according to claim 9 causes a computer to function as given search criteria obtaining means, related search criteria retrieval means, first search results retrieval means, second search results retrieval means, operation log retrieval means, selection criteria identifying means, generating means, and providing means. The given search criteria obtaining means obtains given search criteria given by a user. Search criteria history storage means stores a history of search criteria previously specified by the user. The related search criteria retrieval means retrieves, as related search criteria, search criteria related to the obtained given search criteria, from the search criteria history storage means. Search object storage means stores search objects. The first search results retrieval means retrieves first search results including search objects matching the retrieved related search criteria, from the search object storage means. The second search results retrieval means retrieves second search results including search objects matching the obtained given search criteria, from the search object storage means. Operation history storage means stores search criteria previously specified by the user and operation logs on search objects included in search results retrieved based on the search criteria in association with each other. The operation log retrieval means retrieves operation logs corresponding to the retrieved related search criteria, from the operation history storage means. Based on the retrieved operation logs, the selection criteria identifying means identifies selection criteria. Third search results are among the retrieved first search results and identified based on the retrieved operation logs. Fourth search results are among the retrieved second search results and match the identified selection criteria. Based on a comparison between the third search results and the fourth search results, the generating means generates distinction information that indicates a distinction of the fourth search results. The providing means provides the generated distinction information.

### Advantageous Effects of Invention

According to the present invention, the information processing apparatus identifies selection criteria based on operation logs corresponding to related search criteria that are search criteria previously specified by a user. Among first search results retrieved based on the related search criteria, third search results are identified based on the operation logs. Among second search results retrieved based on given search criteria, fourth search results corresponding to the selection criteria are identified. Based on a comparison between the third search results and the fourth search results, the information processing apparatus generates distinction information that indicates a distinction of the fourth search results. The information processing apparatus provides the generated distinction information. In accordance with some criteria, the user operates a search object from among search results. Thus, the operated search criteria is highly likely to match criteria that the user has been considering. Among the first search results, third search criteria are highly likely to match criteria that the user has been considering. Among the second search results, fourth search criteria match the selection criteria that are likely to be the criteria that the user has been considering. Based on a comparison between the third search criteria and the fourth search criteria, distinction information is generated. Thus, by referring to the distinction information, the user can easily see a difference between search results retrieved based on related search criteria previously specified and search results retrieved based on search criteria given later, under criteria that the user is considering.

### BRIEF DESCRIPTION OF DRAWINGS

FIG. 1 is a diagram schematically showing an example configuration of an information processing system S according to an embodiment.

FIG. 2 is a diagram showing an example of a home page.

FIG. 3 is a diagram showing an example of a search results page.

FIG. 4 is a block diagram schematically showing an example configuration of an online marketplace server 1 according to an embodiment.

FIG. 5 is a diagram showing an example of information that is stored in databases.

FIG. 6 is a diagram showing example functional blocks of a system controller 14 of the online marketplace server 1 according to an embodiment.

FIG. 7A is a diagram illustrating an example of how distinctive search results are extracted.

FIG. 73 is a diagram illustrating an example of how distinctive search results are extracted.

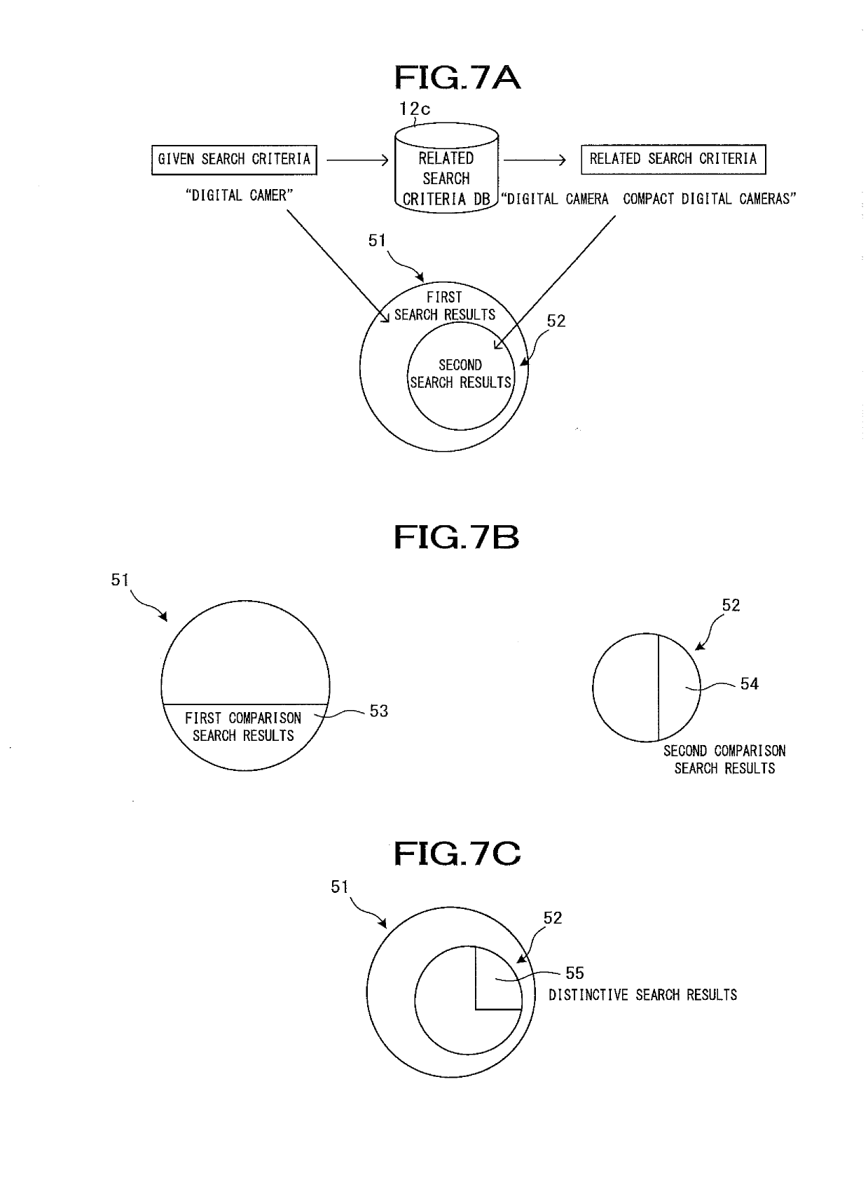

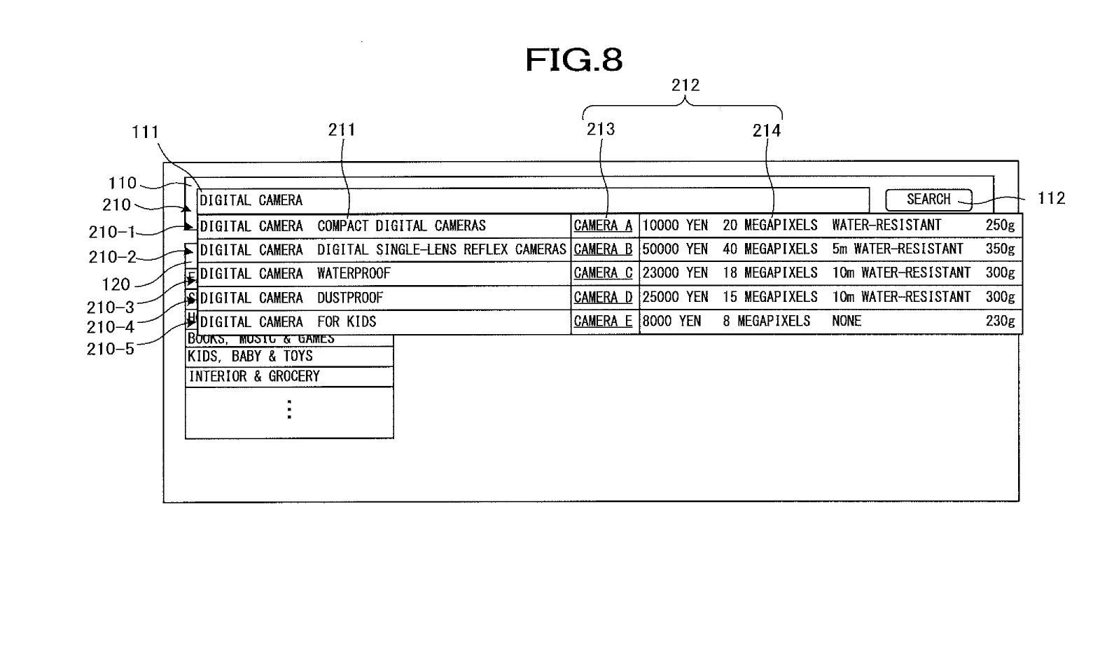

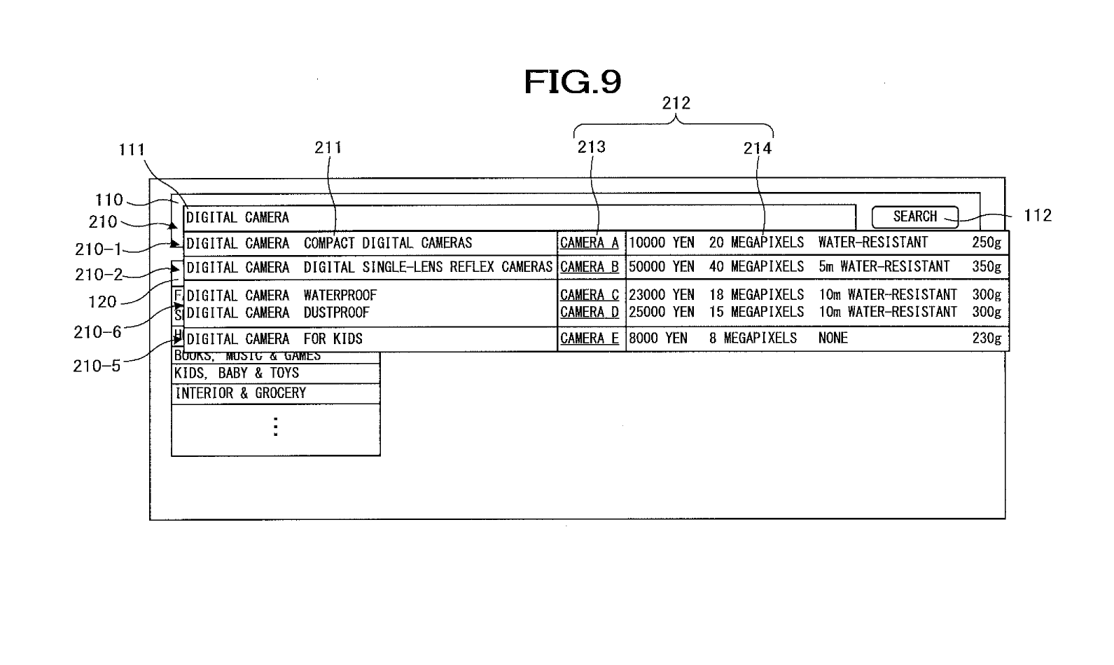

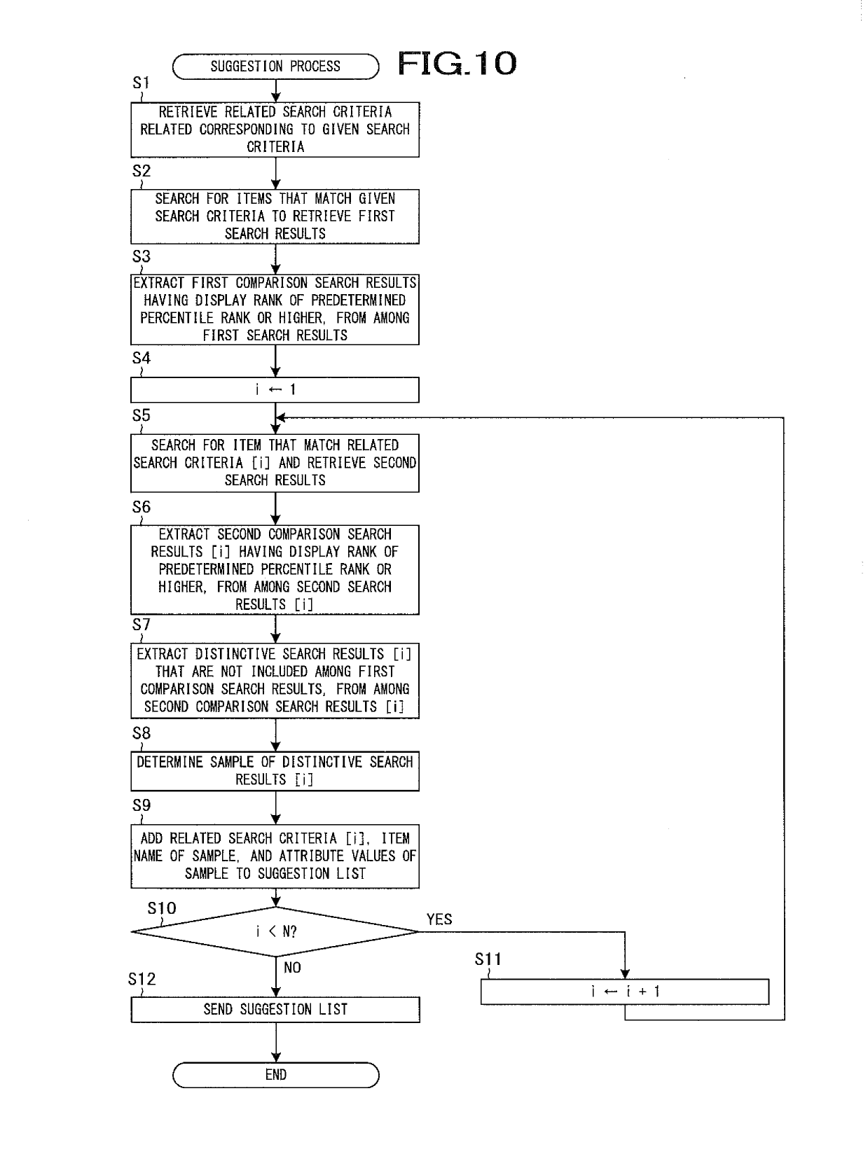

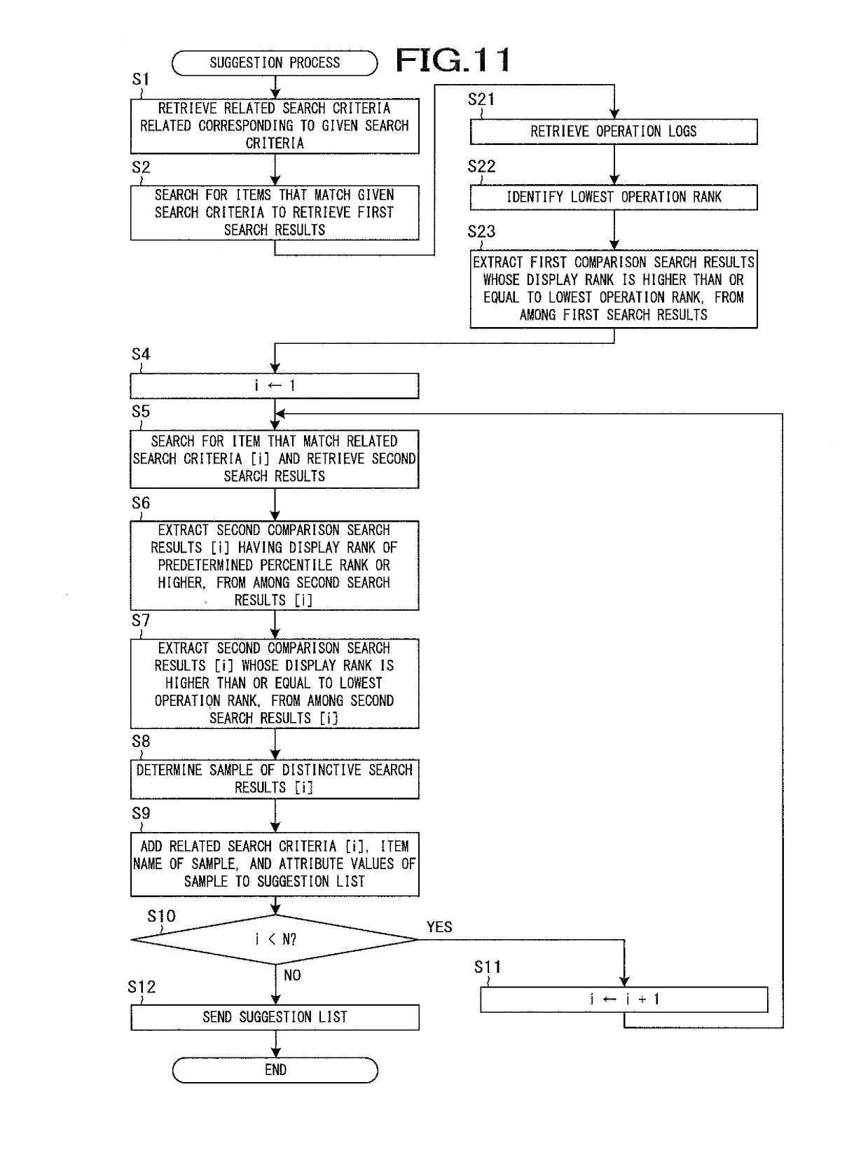

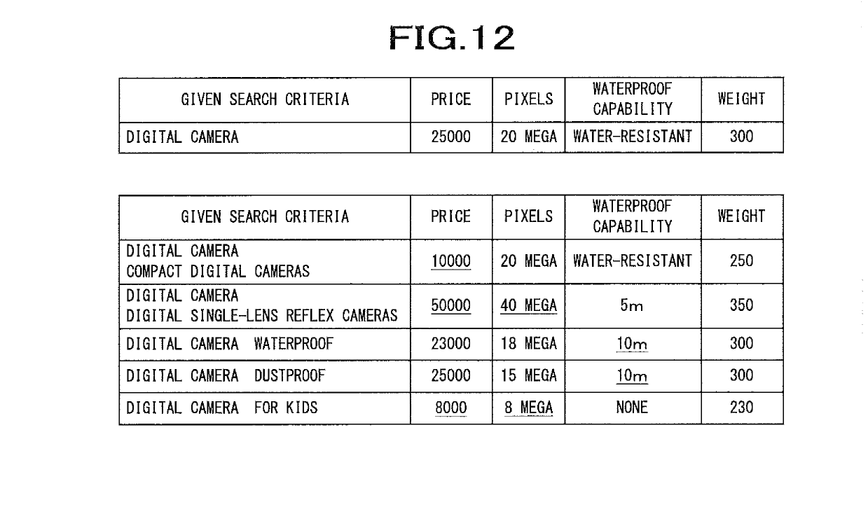

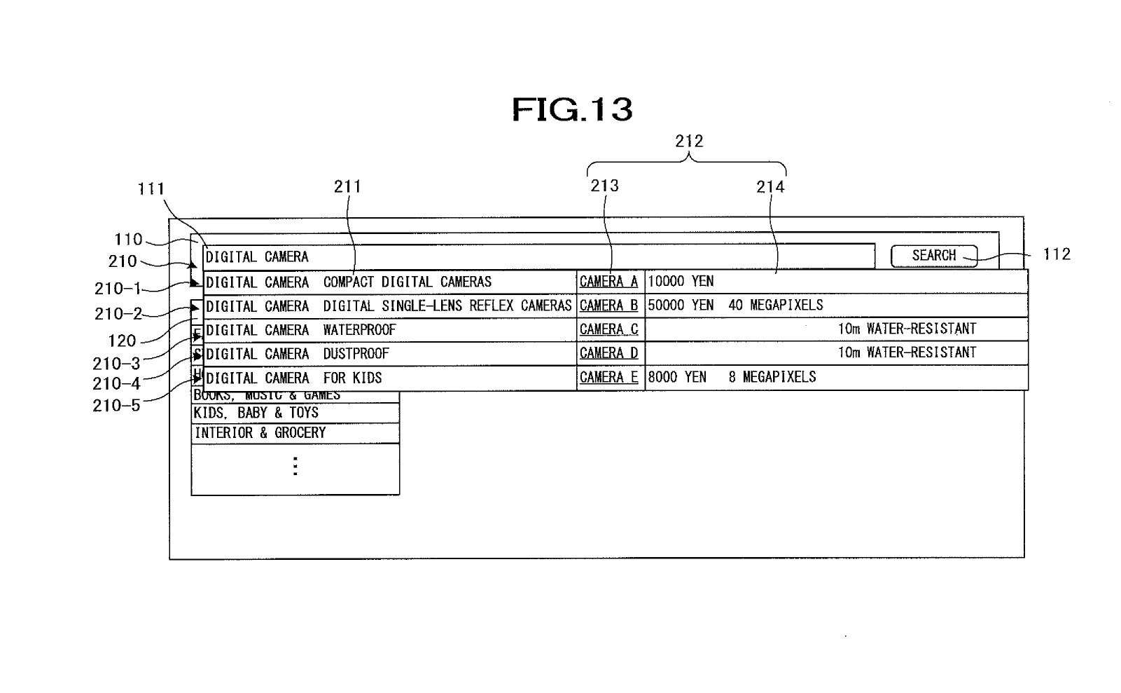

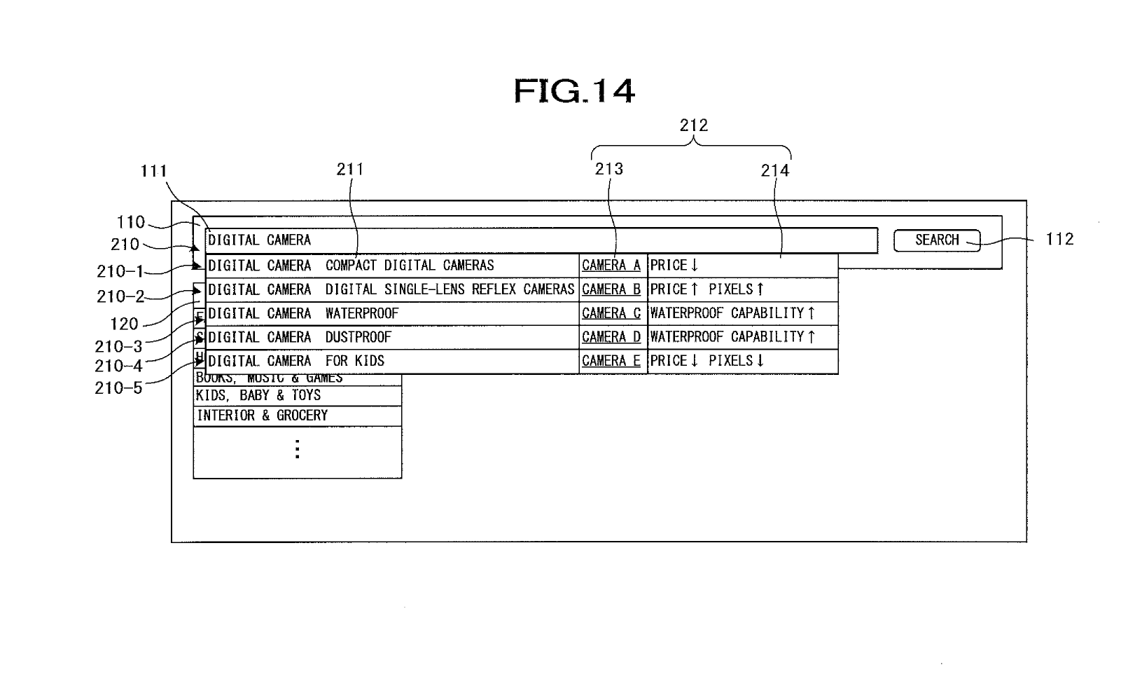

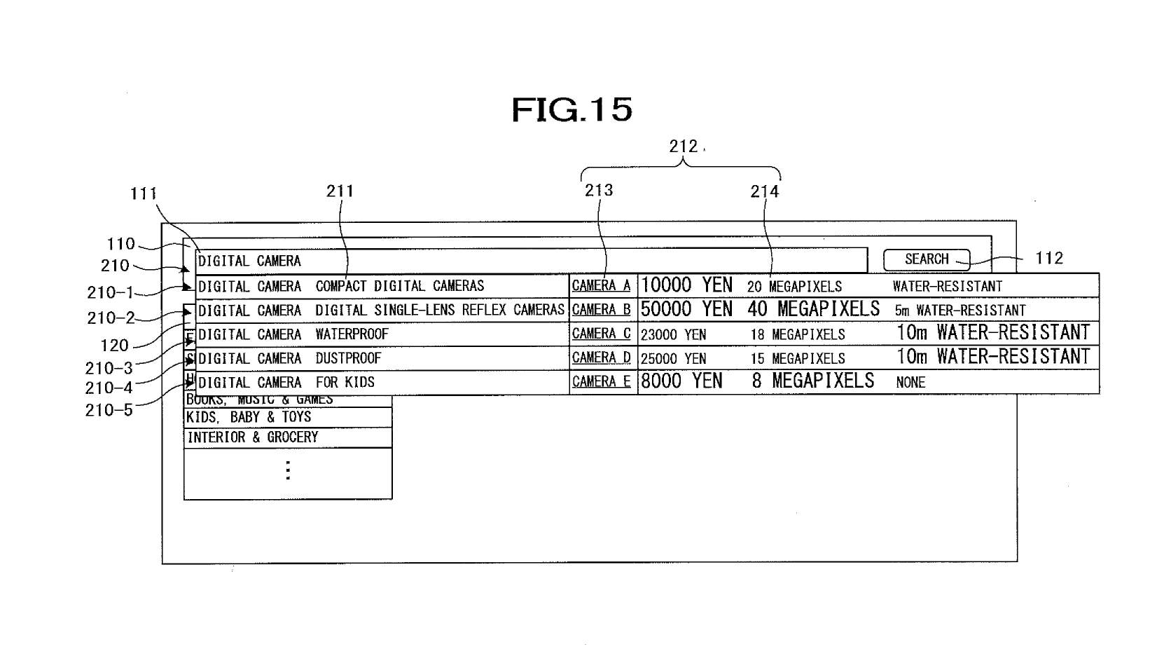

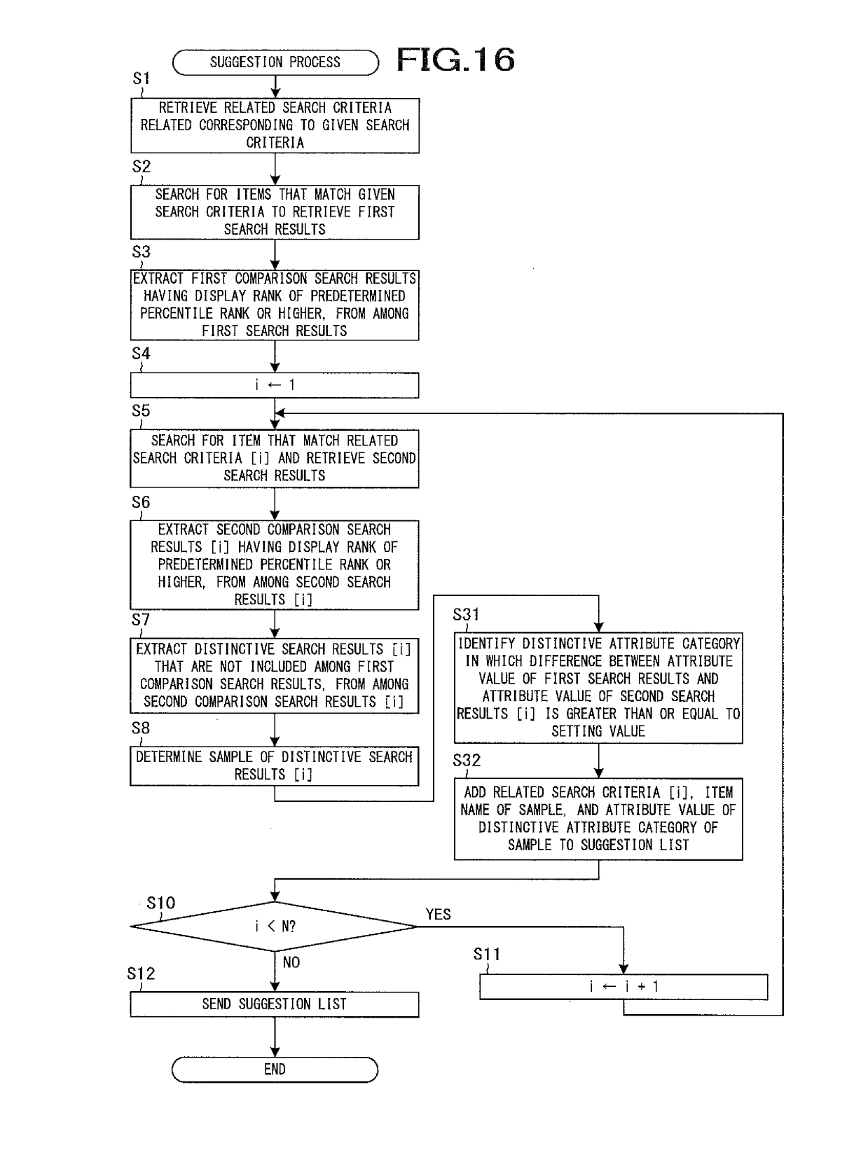

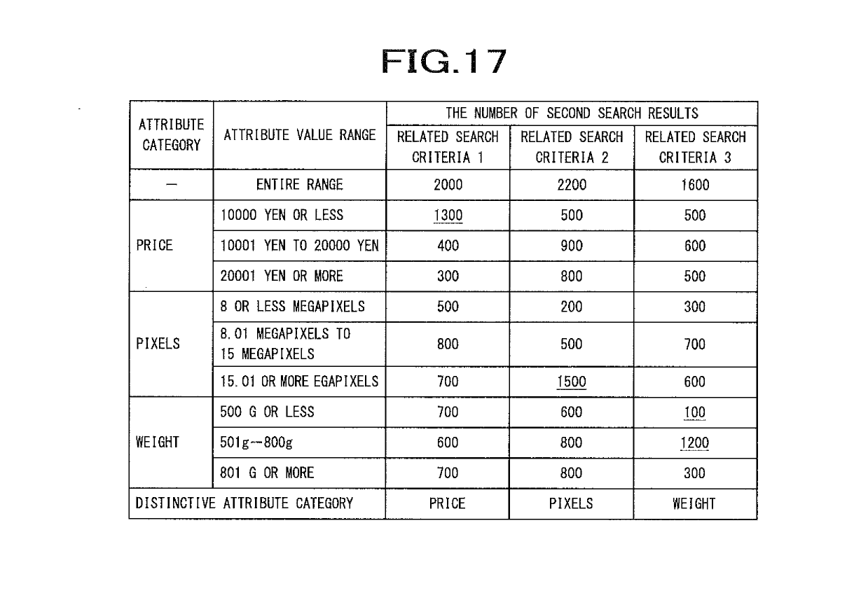

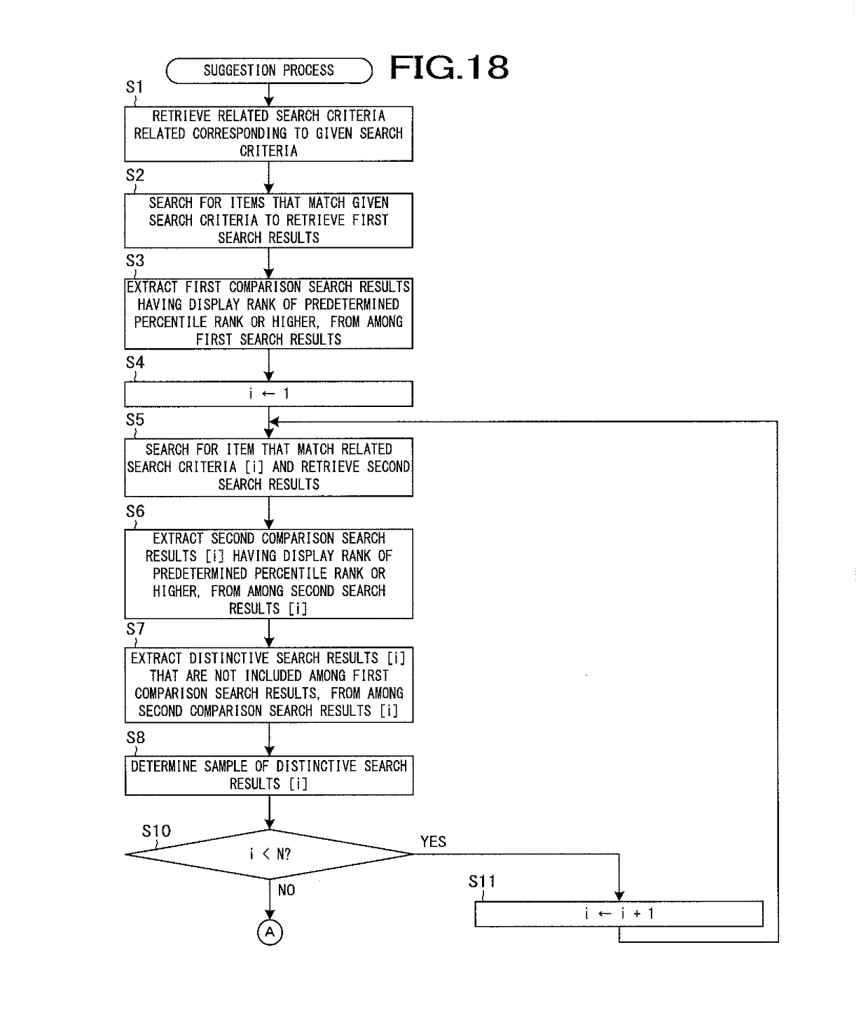

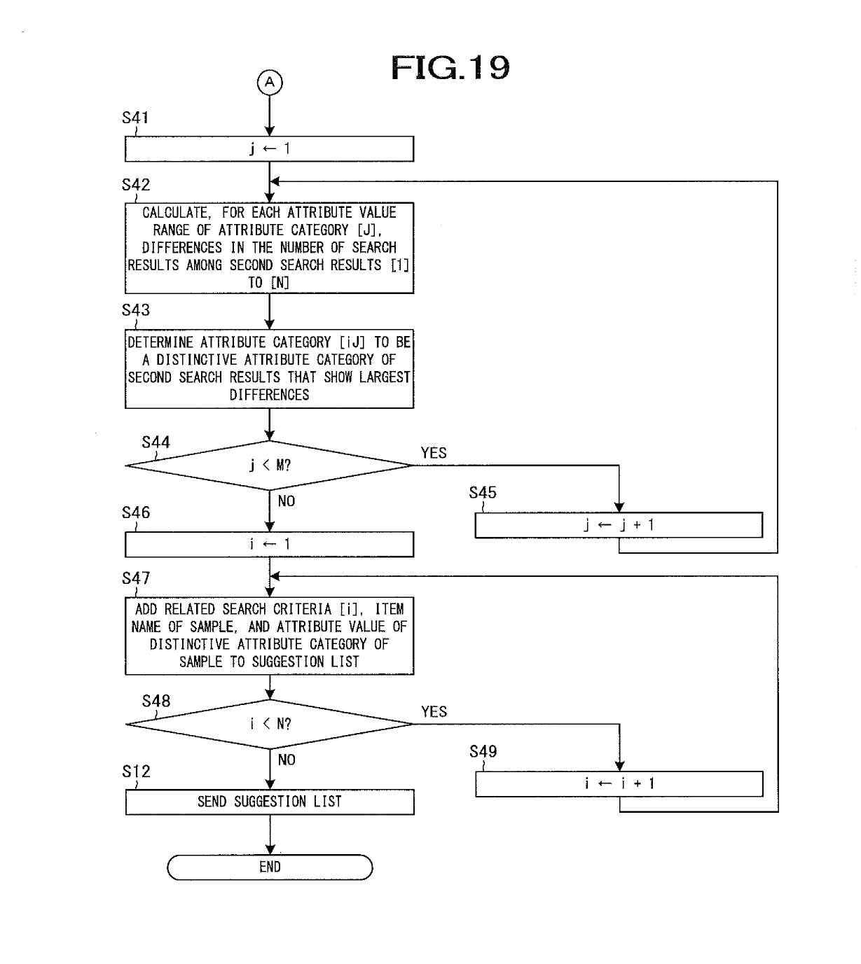

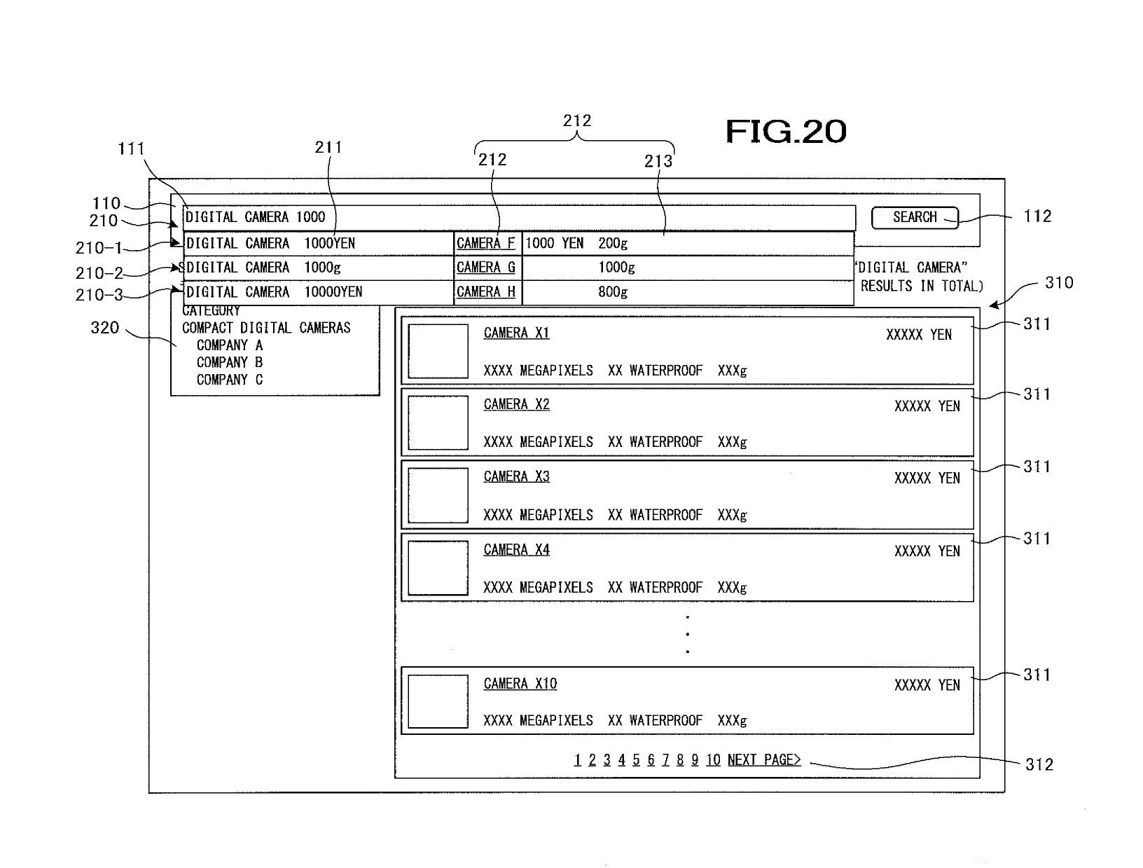

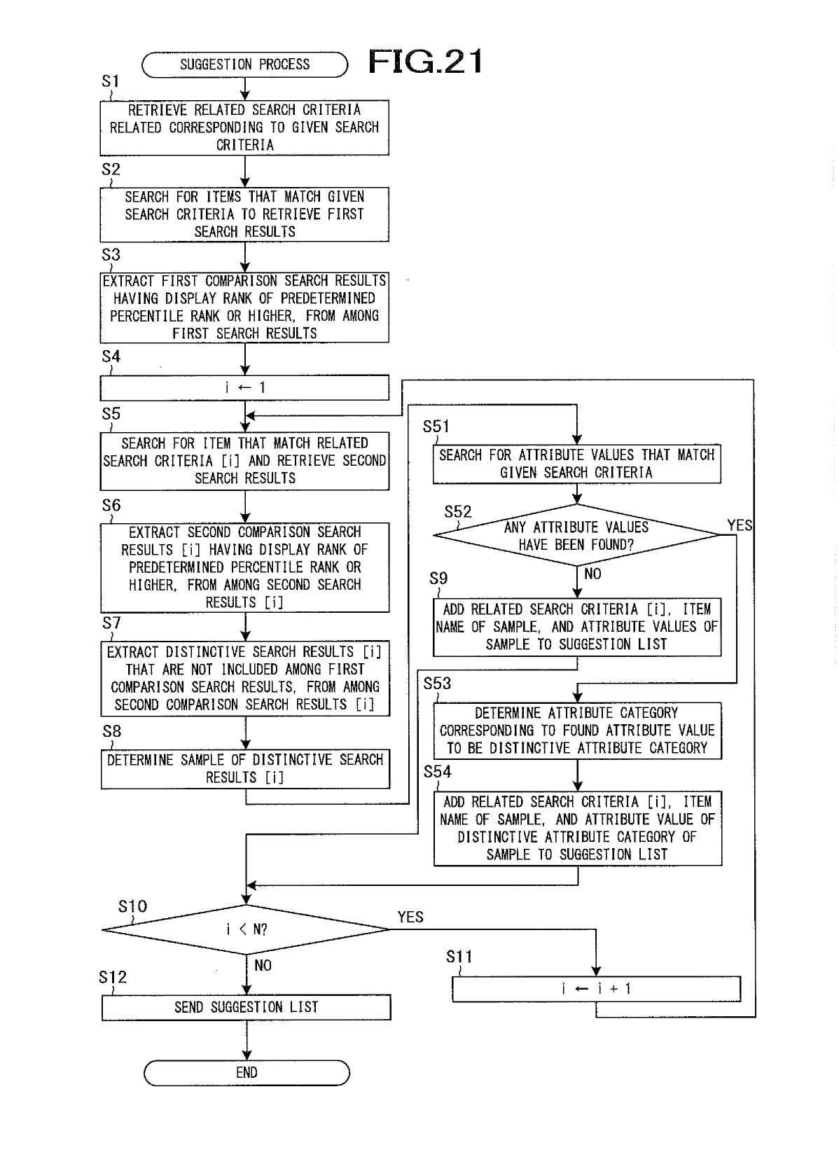

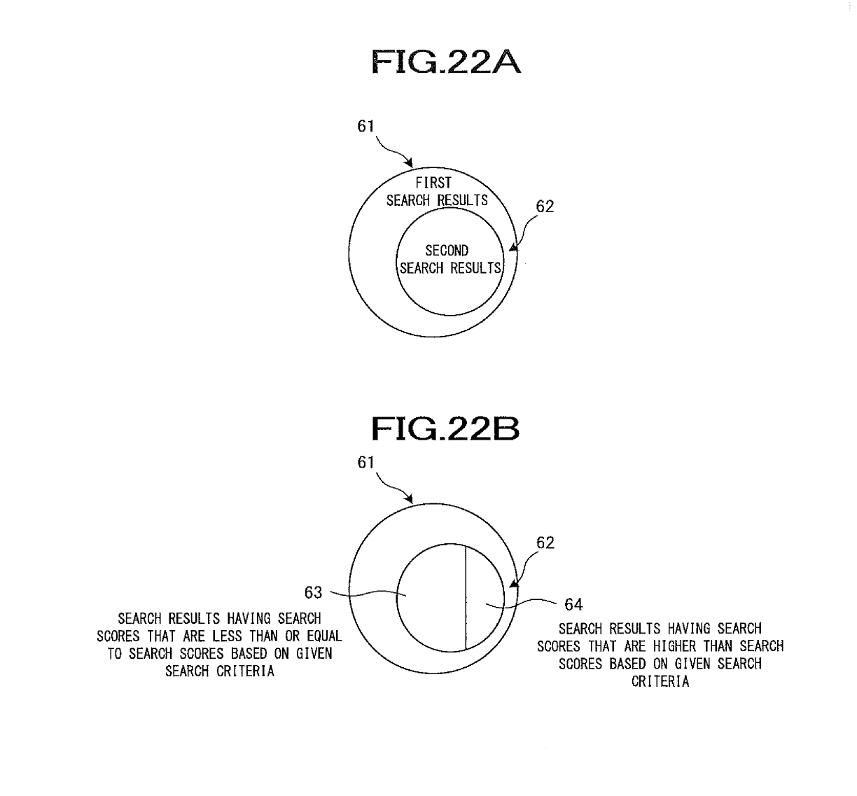

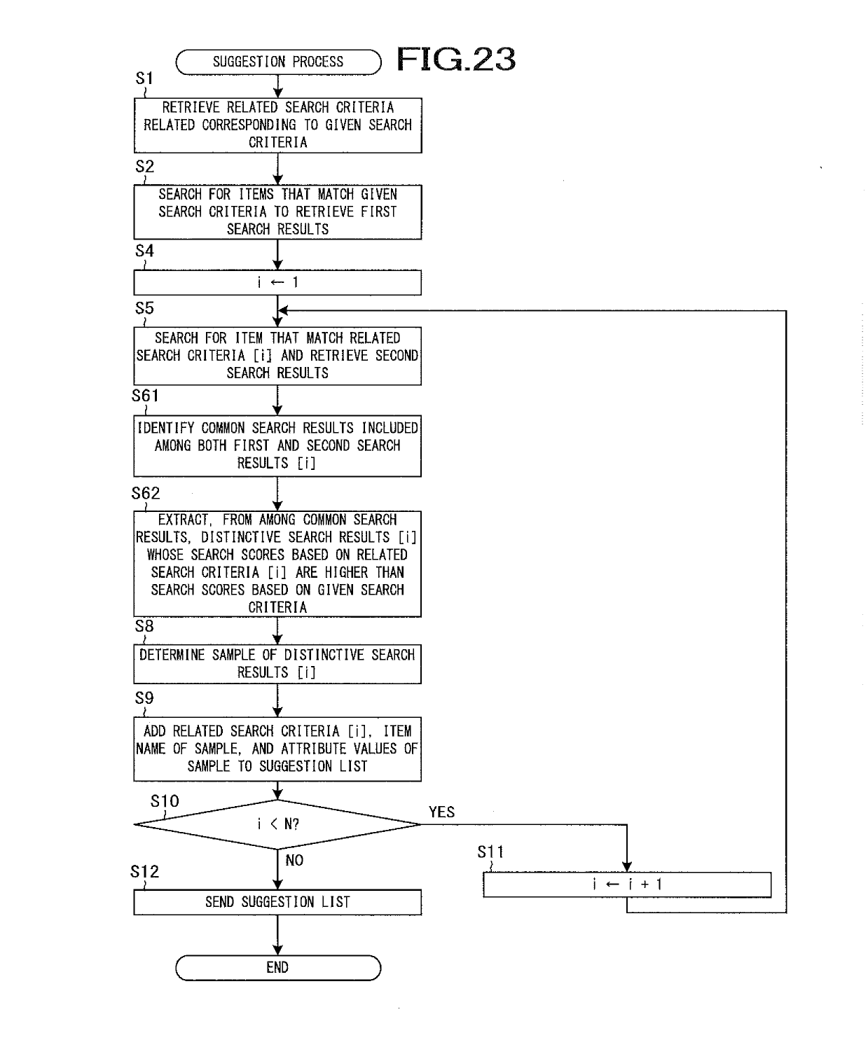

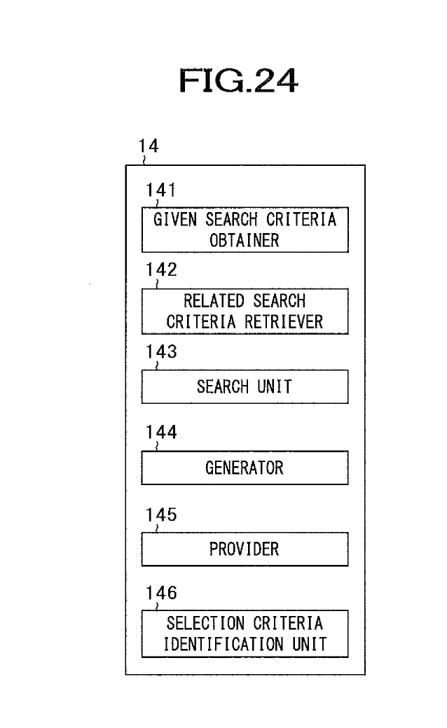

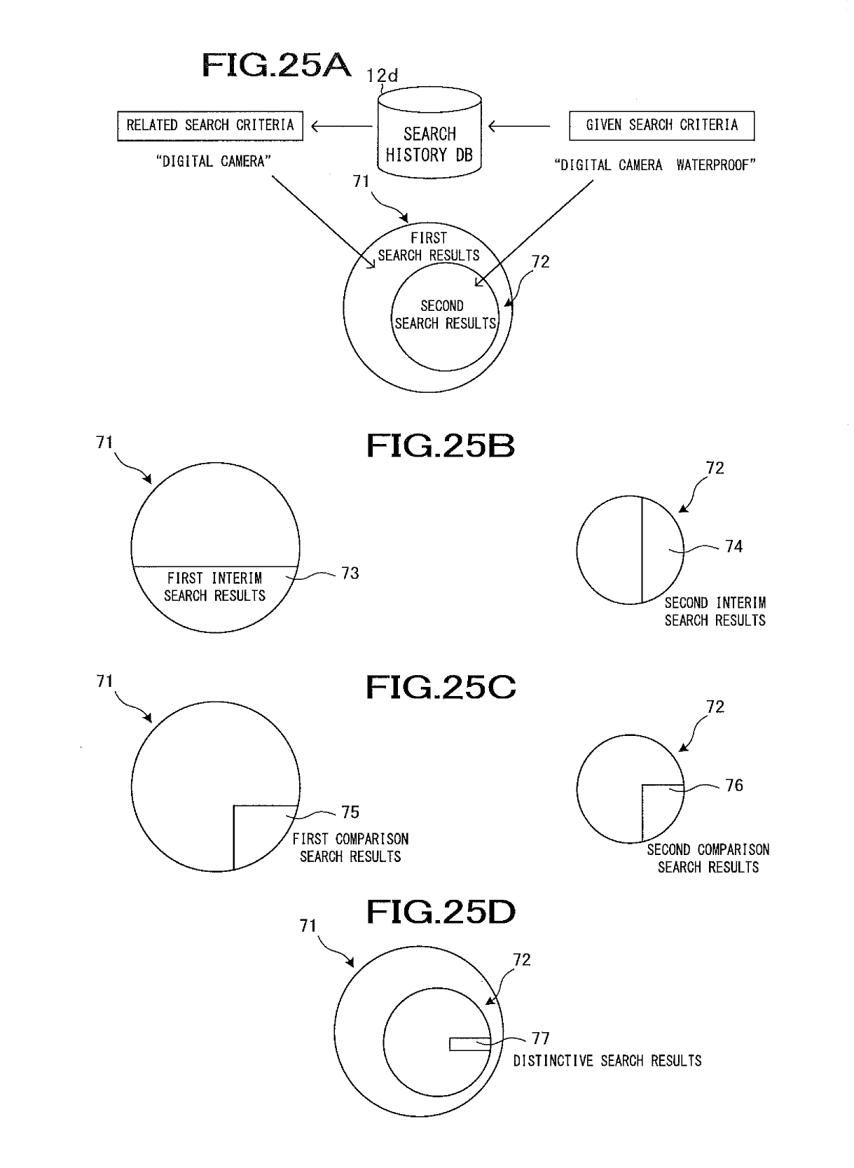

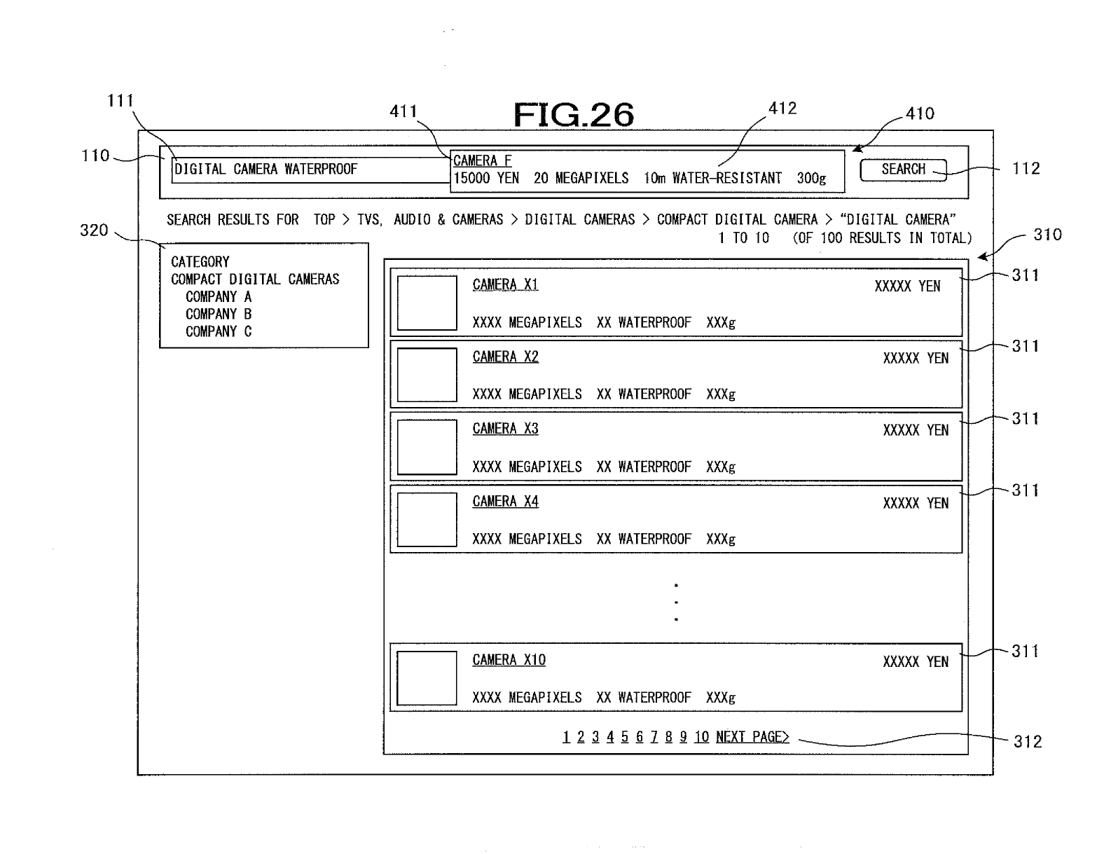

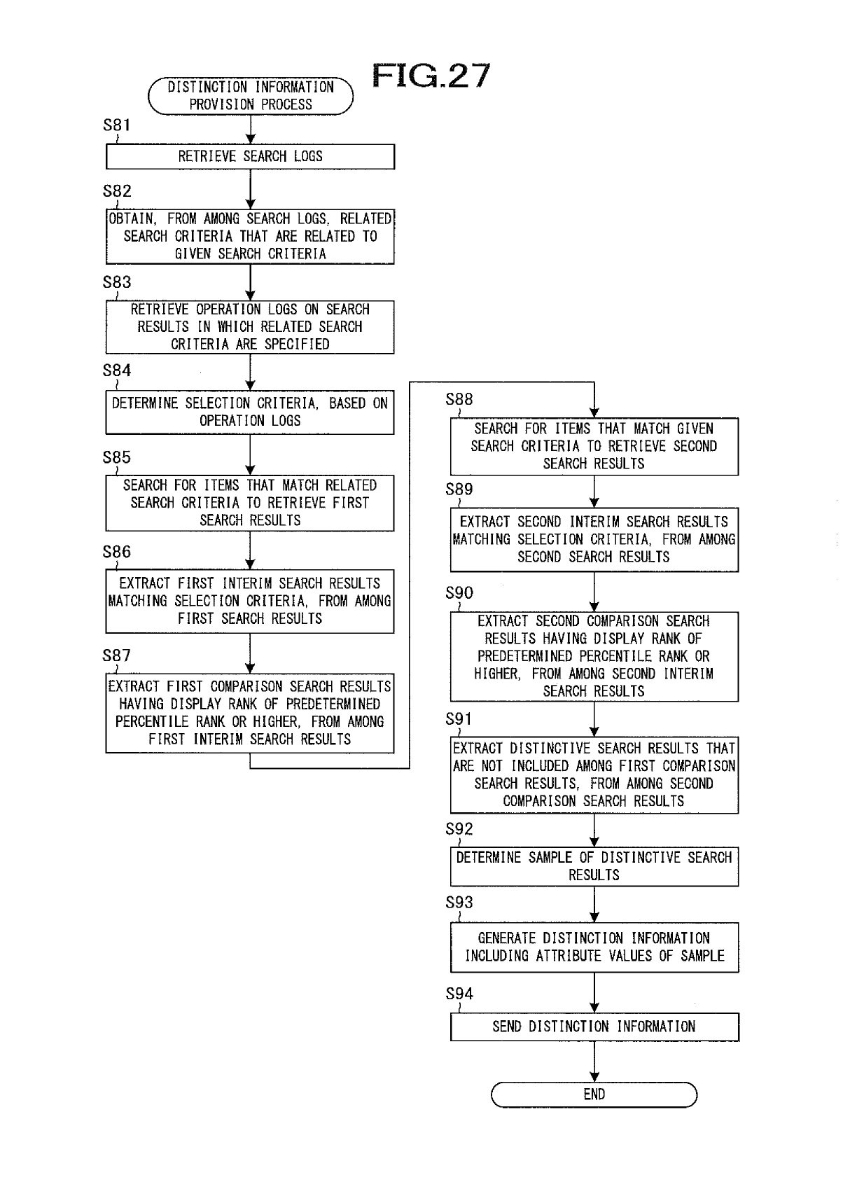

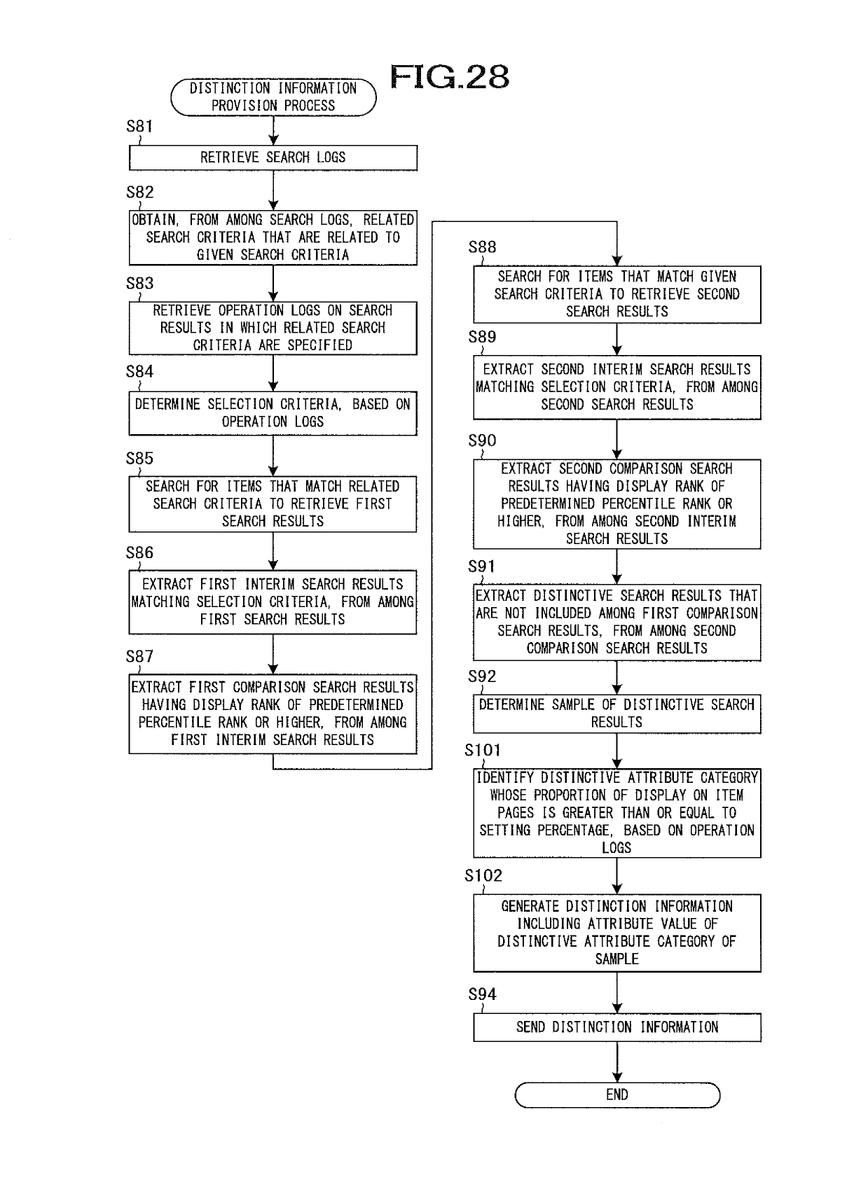

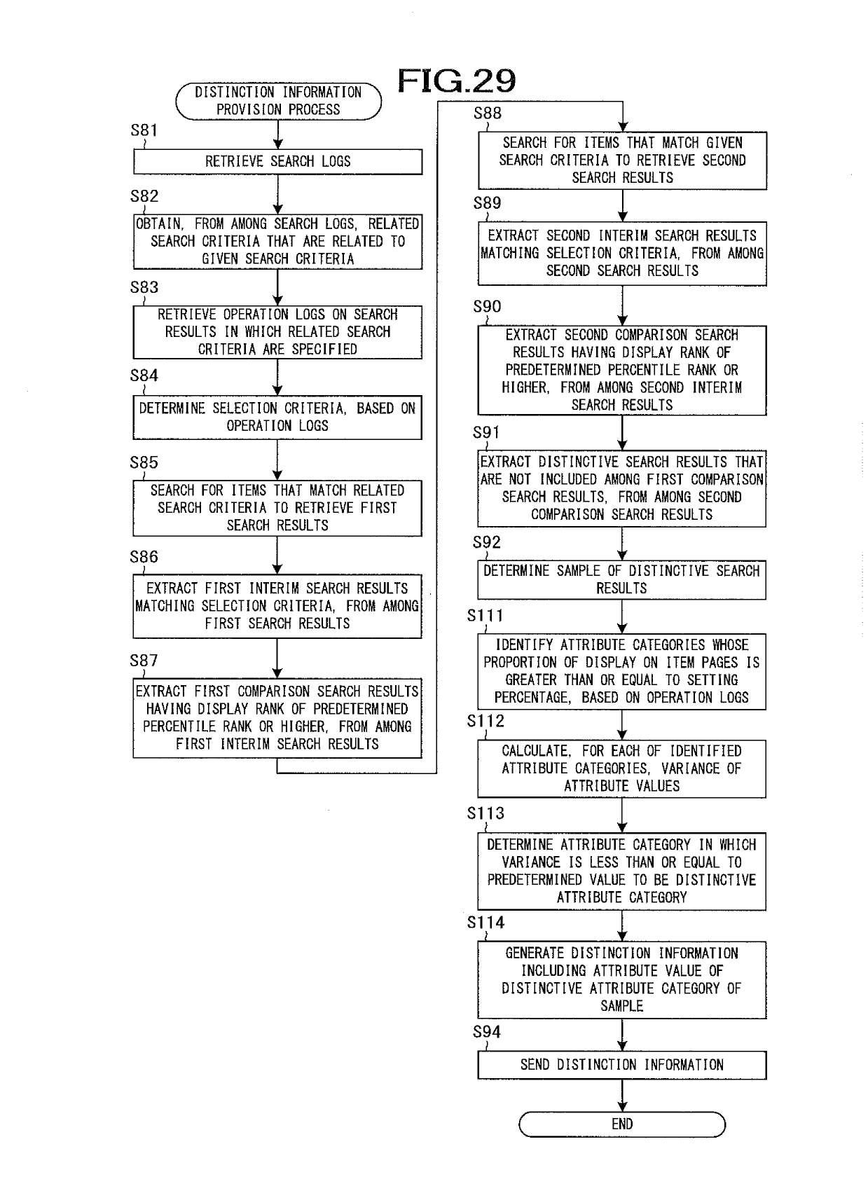

FIG. 7C is a diagram illustrating an example of how distinctive search results are extracted.

FIG. 8 is a diagram showing an example of a suggestion list that is displayed on a home page.

FIG. 9 is a diagram showing an example of the suggestion list that is displayed on the home page.

FIG. 10 is a flowchart showing an example of a search criteria suggestion process in the system controller 14 of the online marketplace server 1 according to an embodiment.

FIG. 11 is a flowchart showing an example of the search criteria suggestion process in the system controller 14 of the online marketplace server 1 according to an embodiment.

FIG. 12 is a diagram showing an example of how a distinctive attribute category is identified.

FIG. 13 is a diagram showing an example of the suggestion list that is displayed on the home page.

FIG. 14 is a diagram showing an example of the suggestion list that is displayed on the home page.

FIG. 15 is a diagram showing an example of the suggestion list that is displayed on the home page.

FIG. 16 is a flowchart showing an example of the search criteria suggestion process in the system controller 14 of the online marketplace server 1 according to an embodiment.

FIG. 17 is a diagram showing an example of how a distinctive attribute category is identified.

FIG. 18 is a flowchart showing an example of the search criteria suggestion process in the system controller 14 of the online marketplace server 1 according to an embodiment.

FIG. 19 is a flowchart showing an example of the search criteria suggestion process in the system controller 14 of the online marketplace server 1 according to an embodiment.

FIG. 20 is a diagram showing an example suggestion list displayed on a search results page.

FIG. 21 is a flowchart showing an example of the search criteria suggestion process in the system controller 14 of the online marketplace server 1 according to an embodiment.

FIG. 22A is a diagram illustrating an example of how distinctive search results are extracted.

FIG. 22B is a diagram illustrating an example of how distinctive search results are extracted.

FIG. 23 is a flowchart showing an example of the search criteria suggestion process in the system controller 14 of the online marketplace server 1 according to an embodiment.

FIG. 24 is a diagram showing example functional blocks of the system controller 14 of the online marketplace server 1 according to an embodiment.

FIG. 25A is a diagram illustrating an example of how distinctive search results are extracted.

FIG. 25B is a diagram illustrating an example of how distinctive search results are extracted.

FIG. 25C is a diagram illustrating an example of how distinctive search results are extracted.

FIG. 25D is a diagram illustrating an example of how distinctive search results are extracted.

FIG. 26 is a search results page showing search results obtained when a combination of the keywords “digital camera” and the category “compact digital cameras” is specified as search criteria on the home page.

FIG. 27 is a flowchart showing an example of a distinction information provision process in the system controller 14 of the online marketplace server 1 according to an embodiment.

FIG. 28 is a flowchart showing an example of the distinction information provision process in the system controller 14 of the online marketplace server 1 according to an embodiment.

FIG. 29 is a flowchart showing an example of the distinction information provision process in the system controller 14 of the online marketplace server 1 according to an embodiment.

### DESCRIPTION OF EMBODIMENTS

The following describes embodiments of the present invention in detail with reference to the drawings. The embodiments described below are embodiments in which the present invention is applied to an information processing system.

### 1. First Embodiment

### 1-1. Configuration and Functional Overview of Information Processing System

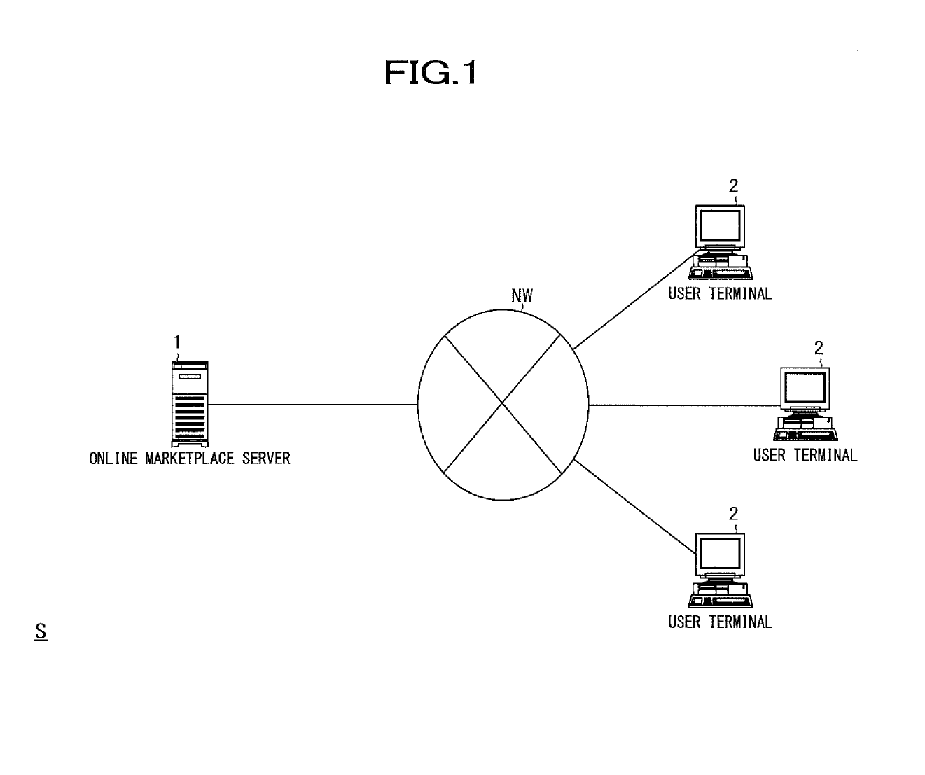

First, a configuration and a functional overview of an information processing system S according to this embodiment are described with reference to FIG. 1. FIG. 1 is a diagram schematically showing an example configuration of the information processing system S according to this embodiment.

As shown in FIG. 1, the information processing system S includes an item search server 1 and a plurality of user terminals 2. The item search server 1 is capable of exchanging data with each user terminal 2 over a network NW using communication protocols, such as TCP/IP. The network NW includes, for example, the Internet, a dedicated communication line (e.g., community antenna television (CATV) line), a mobile communication network (including base stations), and a gateway.

The online marketplace server 1 is a server device that performs processes for an online marketplace in which items can be purchased. For example, user may be able to purchase various items from various stores in the online marketplace. For example, the online marketplace server 1 sends web pages of the online marketplace and performs processes for item searches and orders, in response to requests from the user terminals 2. The online marketplace server 1 is an example of an information processing apparatus according to the present invention. The present invention is not limited to item searches. The present invention can be applied to any search. For example, the present invention may be applied to searches for services, web pages, images, moving images, news, or documents.

The user terminal 2 is a terminal device of a user who uses the online marketplace. The user terminal 2 accesses the online marketplace server 1 in accordance with an operation performed by the user to receive a web page from the online marketplace server 1 and displays the web page. The user terminal 2 has software, such as a browser and an email client, installed on it. For example, a personal computer, a personal digital assistant (PDA), a mobile information terminal such as a smartphone, or a mobile phone is used as the user terminal 2.

### 1-2. Web Pages of Online Marketplace

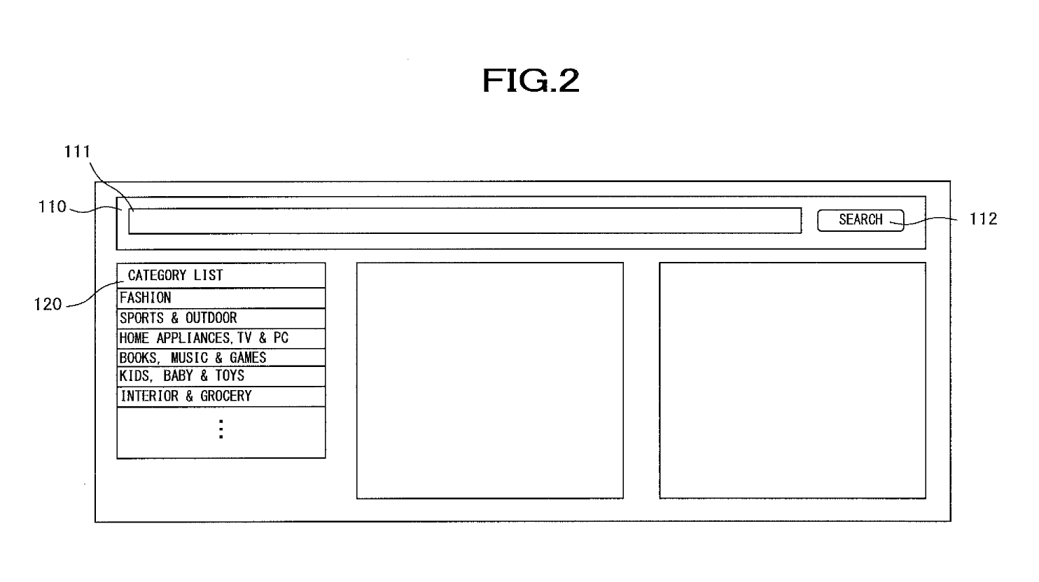

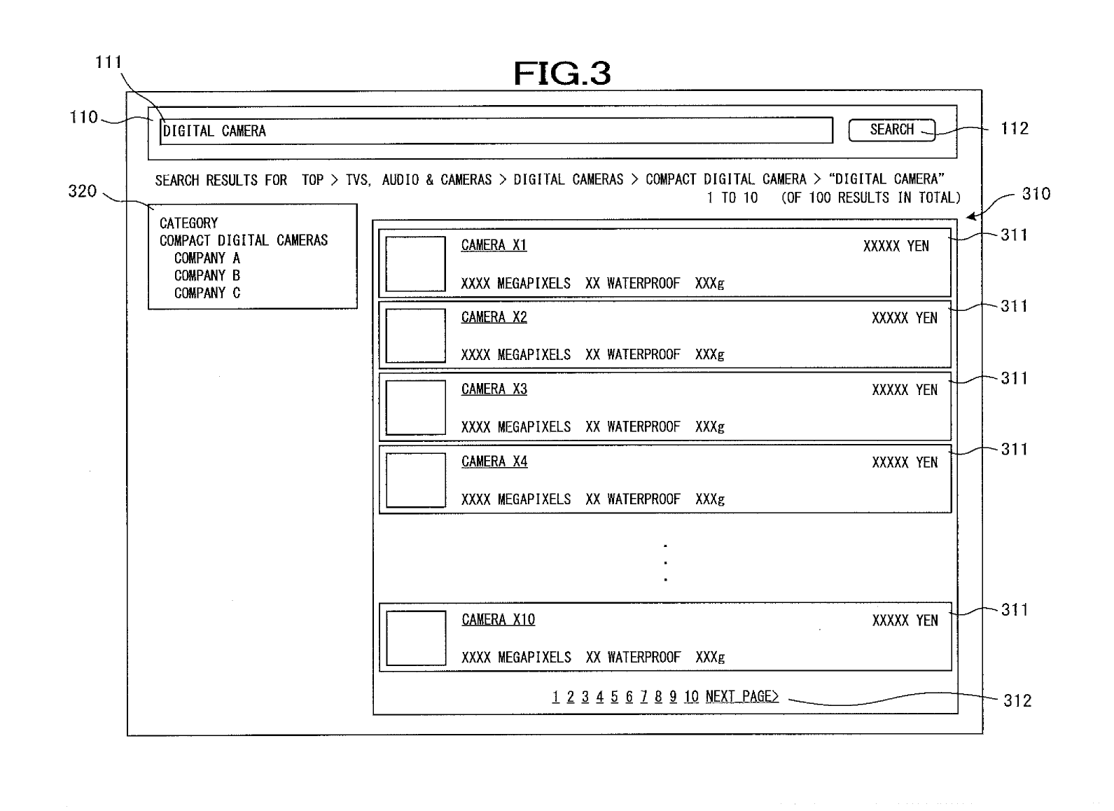

The following describes web pages of the online marketplace with reference to FIGS. 2 and 3. Example types of the web pages of the online marketplace include a home page, a search results page, an item page, and a review page.

FIG. 2 is a diagram showing an example of a home page. The home page is, for example, the web page that is first displayed when a user visits the online marketplace. On the home page, a user can specify search criteria to search for items. As shown in FIG. 2, the home page contains, for example, a search criteria specification area 110 and a category list 120. The search criteria specification area 110 is an area for specifying search criteria. The search criteria specification area 110 contains, for example, a keyword entry field 111 and a search button 112. The keyword entry field 111 is an entry field for entering one or more keywords. The search button 112 is a button for requesting the online marketplace server 1 to search for items with the keywords entered in the keyword entry field ill being specified as search criteria. The category list 120 shows a plurality of categories into which items being sold in the online marketplace are classified. By selecting a category from the category list 120, the user can require the online marketplace server 1 to perform a search with the selected category being specified as search criteria. For example, the home page may be so designed that attributes of items can be specified as search criteria. Also for example, the home page may be so designed that at least two of the types “keyword”, “category”, and “attribute” can be specified together as search criteria.

FIG. 3 is a diagram showing an example of a search results page. The search result page displays the results of a search for items. The online marketplace server 1 searches for items that match search criteria specified by a user and then sends a resulting search results page to the user terminal 2. Also on the search results page, the user can make a search request by specifying search criteria. FIG. 3 shows an example of a search results page that displays search results obtained when the keywords “digital camera” and the category “compact digital cameras” are specified as search criteria. In FIG. 3, the same components as in FIG. 2 are denoted by the same reference signs. As shown in FIG. 3, the search results page contains, for example, the search criteria specification area 110 and a search results list 310.

The keyword entry field 111 in the search criteria specification area 110 is prefilled with keywords specified as the preceding search criteria, which are being displayed in it. For example, the keyword entry field 111 is prefilled with “digital camera”. The user can enter an additional keyword in the entry field 111 or change the keywords already entered in the entry field 111.

The search results list 310 displays, for example, search results. Specifically, the search results list 310 contains, for example, a plurality of item information areas 311 and a page switching link group 312. Each of the item information areas 311 displays information about a found item. For example, the item information area 311 may display the name, an image, the price, attributes of the item. One search results page displays a predetermined number of item information areas 311. In the example shown in FIG. 3, ten item information areas 311 are displayed. However, the number of item information areas 311 that are displayed in a search results page may be other than ten. The page switching link group 312 is a link group for switching from a search results page currently being displayed to another. Immediately after a search is performed, the first search results page is displayed. Each item included in search results is given a display rank. The higher display rank an item is given, the more preferentially the corresponding item information area 311 is displayed. For example, the item information areas 311 for items of the first to tenth display ranks may be displayed on the first search results page. The item information areas 311 for items of the eleventh to twentieth display ranks may be displayed on the second search results page. The item information areas 311 for items of the twenty-first to thirtieth display ranks may be displayed on the third search results page. The display rank of each item may be determined, for example, based on the corresponding search score. A search score is information indicating a relationship between a found item and search criteria specified to search for the item. The higher the search score, the more highly the item and the search criteria are related to each other. The online marketplace server 1 may determine the display ranks of found items in descending order of their search scores.

When a user specifies a category as search criteria and then the online marketplace server 1 searches for items, a category list 320 is further displayed on a resulting search results page. The category list 320 displays a plurality of categories that belong to the category specified as the search criteria. By selecting a category from the category list 320, the user can require the online marketplace server 1 to perform a search with the selected category being specified as search criteria.

The item page is a web page that displays detailed information about one item. When a user selects an item name contained in an item information area 311 on a search results page, the online marketplace server 1 sends an item page corresponding to the item information area 311 to the user terminal 2. The item page displays, for example, the name, images, the price, attributes, and a description of the item and a review link. The review link is a hyperlink to a review page. The review page displays reviews, impressions, or the like on the corresponding item by users who purchased the item.

### 1-3. Configuration of Online Marketplace Server

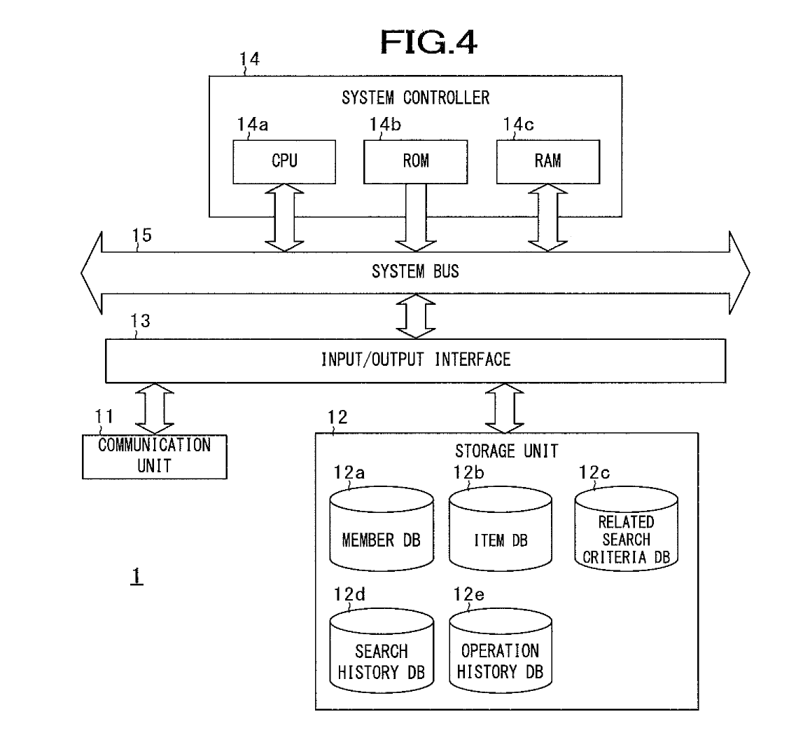

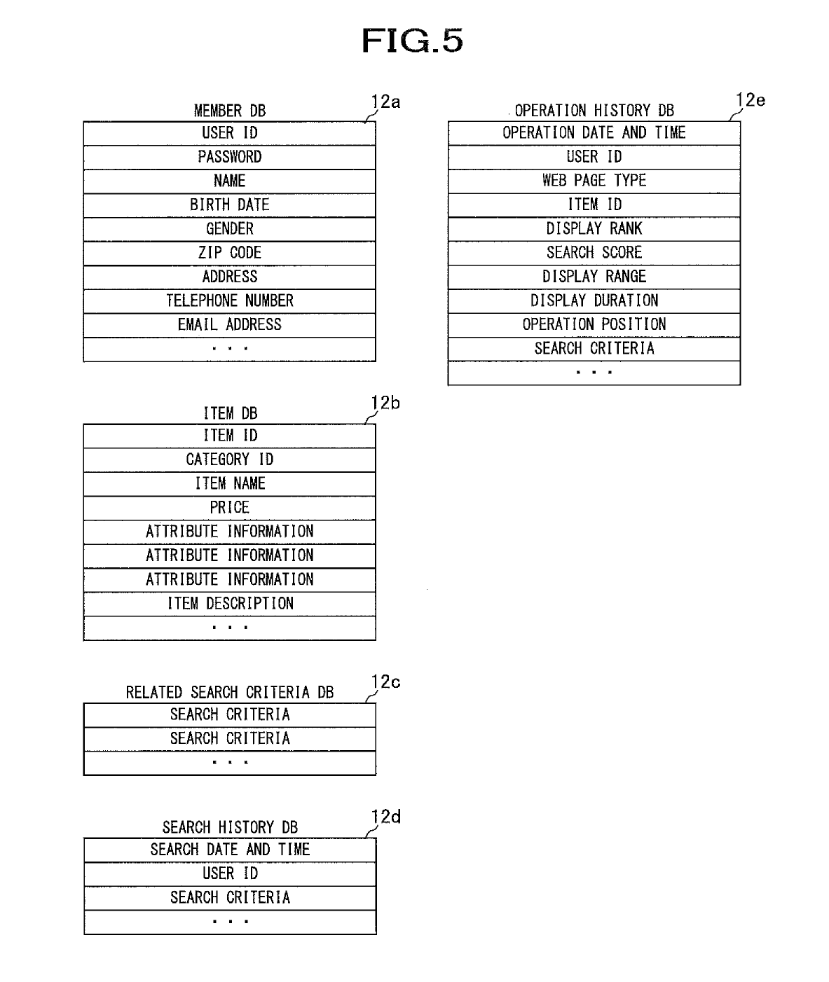

The following describes a configuration of the online marketplace server 1 with reference to FIGS. 4 and 5. FIG. 4 is a block diagram schematically showing an example configuration of the online marketplace server 1 according to this embodiment. As shown in FIG. 4, the online marketplace server 1 includes a communication unit 11, a storage unit 12, an input/output interface 13, and a system controller 14. The system controller 14 and the input/output interface 13 are connected via a system bus 15.

The communication unit 11 connects to the network NW and controls the state of communications with, for example, the user terminals 2.

The storage unit 12 includes, for example, hard disk drives. The storage unit 12 is an example of search object storage means, relationship information storage means, operation history storage means, and search criteria history storage means of the present invention. This storage unit 12 stores a member DB 12a, an item DB 12b, a related search criteria DB 12c, a search history DB 12d, an operation history DB 12e, and other databases. “DB” is an abbreviation for database.

FIG. 5 is a diagram showing an example of information that is stored in databases. The member DB 12a stores member information about users who have signed up for the online marketplace. Specifically, the member information DB 12a stores, for each user, the user's user ID, password, name, birth date, gender, zip code, address, telephone number, email address, and other user attributes in association with each other, as member information. The user ID is identification information for identifying the user.

The item DB 12b stores item information about items being sold in the online marketplace. Specifically, the item DB 12b stores, for each item, the item's item ID, category ID, name, price, one or more pieces of attribute information, description, and other information in association with each other, as item information. The item ID is identification information for identifying the item. The category ID is identification information for identifying a category to which the item belongs. The items being sold in the online marketplace are classified into a plurality of categories. Examples of the categories include fashion, sports, home appliances, personal computers, books, music, games, and food. Some categories may be further divided into a plurality of categories. For example, fashion may be divided into men's fashion, ladies fashion, shoes, and bags. The category ID stored in the item DB 12b may be, for example, the category ID of the most detailed category. Each piece of attribute information indicates an attribute of the item. For example, the attribute information may include an attribute category and an attribute value. A combination of the attribute category and the attribute value indicates an attribute. The attribute category may be, for example, an attribute item, an attribute type, or an attribute name. The attribute category may be vary depending on the corresponding category. Examples of the attribute category of an item in the category of digital cameras include “CCD pixels”, “waterproof capability”, and “weight”. Examples of the attribute category of “bags” may include “material” and “color”. The attribute value indicates an attribute corresponding to the attribute category of the item. For example, when the attribute category is “pixels”, its attribute value may be “20 megapixels”. Also for example, when the attribute category is “waterproof capability”, its attribute value may be “water-resistant”. The price is an attribute that every item has.

The related search criteria DB 12c stores information indicating a relationship between search criteria. The search criteria are used to search for items. The search criteria may include, for example, at least a keyword, a category, and an attribute. The search criteria may include, for example, a plurality of keywords, a plurality of categories, or a plurality of attributes. Also for example, the search criteria may be a combination of at least two of a keyword, a category, and an attribute. For example, the related search criteria DB 12c may store, for each combination of related search criteria, search criteria and search criteria related to the search criteria.

The search history DB 12d stores item search histories. Specifically, every time a search is performed, a search date and time, a user ID, search criteria, and other information are stored in association with each other, as a search log, in the search history DB 12d. The search date and time indicates the date and time at which the search was performed. The user ID indicates the user who requested the search. The search criteria are specified for the search by the user indicated by the user ID. The search log also indicates a log of search criteria specified by the user. When a user specifies search criteria, the user terminal 2 sends a search request including the specified search criteria and the user ID of the user to the online marketplace server 1. The system controller 14 searches for items that match the search criteria included in the search request. At this point, the system controller 14 obtains the current date and time as the search date and time. The system controller 14 stores the search date and time, and the user ID and the search criteria that are included in the search request in the search history DB 12d.

The operation history DB 12e stores histories of user operations in the online marketplace application. Specifically, every time an operation is performed, an operation date and time, a user ID, a web page type, an item ID, a display rank, a search score, a display range, a display duration, an operation position, and search criteria stored in association with each other, as an operation log, in the operation history DB 12e. The operation date and time indicates the date and time at which the operation was performed. The user ID indicates the user who performed the operation. The web page type indicates the type of the web page on which the operation was performed. Example types of the web page include a home page, a search results page, an item page, and a review page. An operation log on a search results page is an operation log on a search object included in search results retrieved based on search criteria previously specified by the user. A combination of the item ID, the display rank, and the search score is displayed for each item about which information is displayed on a web page.

For the home page, the operation log may not include this combination. For a search results page, the operation log includes a combination of the item ID, the display rank, and the search score of each of a plurality of items that were displayed as search results. For an item page and a review page, the operation log includes a combination of the item ID, the display rank, and the search score. The display range indicates which range in the entire web page was actually displayed by the user terminal 2. Only part of the web page may be displayed, depending on the screen size of the user terminal 2 or the window size of the browser. The display duration is the length of time during which the corresponding display range of the web page remained displayed. The operation position indicates the position of an element that the user operated on the entire web page. For example, every time the user performs an operation on a web page of the online marketplace, the user terminal 2 may send a request corresponding to the operation. Examples of this operation may include an operation to request a web page and an operation to change the display version of a web page. In response to the request received from the user terminal 2, the system controller 14 stores an operation log in the operation history DE 12e.

The storage unit 12 further stores various data, such as hypertext markup language (HTML) documents, extensible markup language (XML) documents, image data, text data, and electronic documents, for displaying web pages. The storage unit 12 also stores various setting values. One type of web page for which an HTML document is stored in the storage unit 12 is an item page. For example, an item page may be generated based on the item information stored in the item DB 12b.

The storage unit 12 also stores various programs, such as an operating system, a World Wide Web (WWW) server program, a database management system (DBMS), and an e-commerce control program. The e-commerce control program is a program for performing, for example, a search for items. The various programs may be available from, for example, another server device over the network NW. Alternatively, the various programs may be recorded in a recording medium, such as a magnetic tape, an optical disk, or a memory card, and be read via a drive device. The e-commerce control program and other programs may be program products.

The input/output interface 13 performs interface processing between the communication unit 11 and the storage unit 12, and the system controller 14.

The system controller 14 includes, for example, a central processing unit (CPU) 14a, a read only memory (ROM) 14b, and a random access memory (RAM) 14c. The CPU 14a is an example processor. The present invention can also be applied to various processors that differ from CPUs. The storage unit 12, the ROM 14b, and the RAM 14c are each an example memory. The present invention can also be applied to various memories that differ from hard disks, ROMs, and RAMs.

The online marketplace server 1 may include a plurality of server devices. For example, a server device that handles item searches in the online marketplace, a server device that sends web pages in response to requests from store terminals 3 and the user terminals 2, a server device that manages databases, and other server devices may be connected to each other via a LAN or the like.

### 1-4. Functional Overview of System Controller

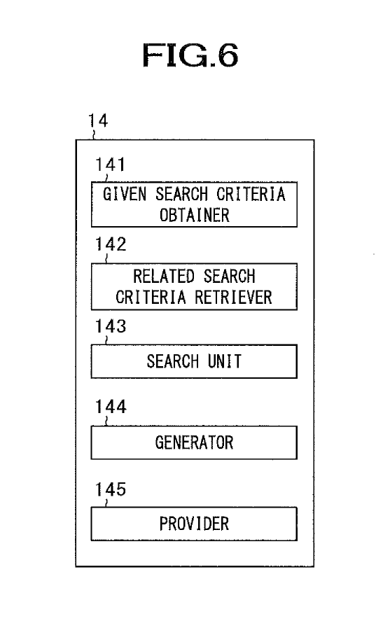

The following describes a functional overview of the system controller 14 with reference to FIGS. 6 to 9. FIG. 6 is a diagram showing example functional blocks of the system controller 14 of the online marketplace server 1 according to this embodiment. As shown in FIG. 6, the e-commerce management program and other programs, which are read and executed by the CPU 14a, enable the system controller 14 to function as, for example, an given search criteria obtainer 141, a related search criteria retriever 142, a search unit 143, a generator 144, and a provider 145.

The given search criteria obtainer 141 is an example of given search criteria obtaining means of the present invention. The related search criteria retriever 142 is an example of related search criteria retrieval means of the present invention. The search unit 143 is an example of first search results retrieval means, second search results retrieval means, rank identifying means, first relationship obtaining means, and second relationship obtaining means of the present invention. The generator 144 is an example of generating means, criteria attribute category identifying means, and attribute category identifying means of the present invention. The provider 145 is an example of providing means of the present invention.

In this embodiment, when a user enters keywords on the home page or a search results page, the system controller 14 causes the user terminal 2 to display a plurality of sets of related search criteria that are related to given search criteria including the entered keywords. By selecting one of the displayed sets of related search criteria, the user can specify the selected related search criteria as search criteria to be used for a search. The system controller 14 searches for items that match the selected related search criteria.

When related search criteria are displayed, it would be convenient for the user to be able to see differences between search results retrieved based on the given search criteria and search results to be retrieved based on the related search criteria. When a plurality of sets of related search criteria are displayed, it would also be convenient for the user to be able to see how differences between search results retrieved based on the given search criteria and search results to be retrieved based on each set of related search criteria change depending on the related search criteria. Thus, the system controller 14 provides, for each set of related search criteria, the related search criteria and distinction information that indicates a distinction of search results based on the related search criteria relative to search results based on the given search criteria to the user terminal 2.

The given search criteria obtainer 141 obtains given search criteria given from a user to the user terminal 2 or the online marketplace server 1. The given search criteria may include at least either search criteria entered or search criteria selected by the user. The given search criteria differ from search criteria specified by the user in whether they are search criteria that the user confirmed to cause the online marketplace server 1 to search for items and the user terminal 2 to display a resulting search results page. The specified search criteria are search criteria that were confirmed. The given search criteria are search criteria that were entered or selected by the user, but are not necessarily search criteria that were confirmed. For example, when the user presses the search button 112, search criteria are confirmed.

For example, every time the user enters a character in the keyword entry field 111 on the home page or a search results page, the user terminal 2 may send keyword(s) currently being entered in the keyword entry field 111 as given search criteria to the online marketplace server 1. Also for example, there may be a case where the search unit 143 searches for items that match a category specified by the user and then a resulting search results page is displayed on the user terminal 2. In this case, every time the user enters a character in the keyword entry field 111 on the search results page, the user terminal 2 may send given search criteria including both the category ID of the specified category and keyword(s) currently being entered in the keyword entry field 111 to the online marketplace server 1. In the example shown in FIG. 3, if the user adds “case” in the keyword entry field 111, the user terminal 2 sends given search criteria including both the category ID of the category “compact digital cameras” and the keywords “digital camera case”.

The related search criteria retriever 142 retrieves, from the related search criteria DB 12c, a plurality of sets of related search criteria that are related to the given search criteria obtained by the given search criteria obtainer 141. For example, the related search criteria retriever 142 may retrieve a predetermined number of sets of related search criteria.

Based on the given search criteria obtained by the given search criteria obtainer 141, the search unit 143 retrieves, from the item DB 12b, first search results including items matching the given search criteria. The first search results indicate one or more items matching the given search criteria. Each search result included among the first search results is item information indicating one item. For example, the first search results include, as search results, at least the item ID of each of the items matching the given search criteria. When the given search criteria include one or more keywords, the search unit 143 searches for item information that includes the keywords, for example, in either its item name or its item description. When the given search criteria include a category ID, the search unit 143 searches for item information that matches the category identified by the category ID in the given search criteria or that includes category IDs of categories that belong to the category. When the given search criteria include a plurality of criteria, the search unit 143 may search for, for example, item information that satisfies all the criteria. The search unit 143 obtains item IDs from each found piece of item information and generates first search results including the item IDs.

The search unit 143 may retrieve first search results from which a display rank of each of search results included among the first search results can be identified. For example, the search unit 143 may determine the display ranks based on search scores. For example, the search unit 143 may obtain, for each found item, a search score related to the given search criteria. For example, the search unit 143 may assign a higher search score to a search result having a higher relationship between the given search criteria and at least one of an item name, a category, an attribute, and an item description that are indicated by the corresponding found item information. The search unit 143 may determine the display ranks in another way. For example, the search unit 143 may generate first search results including, for each search result, the search result and the corresponding display rank. Alternatively, for example, the search unit 143 may arrange the first search results in order of display rank. The search unit 143 may generate first search results including, for each search result, the search result and the corresponding search score or may generate first search results not including any search score.

The search unit 143 retrieves, for each set of related search criteria included among the plurality of sets of related search criteria retrieved by the related search criteria retriever 142, second search results including items matching the related search criteria from the item DB 12b, based on the related search criteria. The second search results indicate one or more items matching the related search criteria. Each search result included among the second search results indicates one item. For example, the second search results include, as search results, at least the item ID of each of the items matching the related search criteria. The second search results are retrieved in the same manner as the first search results.

The generator 144 generates, for each set of related search criteria included among the plurality of sets of related search criteria retrieved by the related search criteria retriever 142, distinction information that indicates a distinction of the second search results relative to the first search results, based on a comparison between the first search results and the second search results. For example, the generator 144 may extract, as distinctive search results, search results that are included among the second search results and not included among the first search results. The distinctive search results are search results that have some distinctions relative to the first search results, among the second search results.

The second search results may be included among the first search results. For example, assume that the given search criteria are the keywords “digital camera” and that a corresponding set of related search criteria are a combination of the keywords “digital camera” and the category “compact digital cameras”. Second search results matching the combination of the keywords “digital camera” and the category “compact digital cameras” are included among first search results matching the keywords “digital camera”. The generator 144 may extract search results used for a comparison, for example, from both the first and second search results. Search results extracted for the comparison from the first search results are referred to as first comparison search results. Search results extracted for the comparison from the second search results are referred to as second comparison search results. The generator 144 may extract, as distinctive search results, search results that are included among the second comparison search results and not included among the first comparison search results. When the second search results include search results that do not overlap with the first search results, the generator 144 may extract, as distinctive search results, the search results that do not overlap with the first search results.

The generator 144 may extract first comparison search results and second comparison search results, for example, based on search scores. For example, the generator 144 may extract, from among the first search results, search results having a display rank between first and a predetermined percentile rank inclusive, as first comparison search results. For example, the generator 144 may then extract, from among the second search results, search results having a display rank between first and a predetermined percentile rank inclusive, as second comparison search results. Alternatively, the generator 144 may extract, from among the first search results, a predetermined percentage of search results of higher display rank, as first comparison search results. The generator 144 may then extract, from among the second search results, a predetermined percentage of search results of higher display rank, as second comparison search results. Alternatively, the generator 144 may extract, from among the first search results, search results with a preinstalled score or higher as first comparison search results. The generator 144 may then extract, from among the second search results search results with a predetermined score or higher as second comparison search results. As described above, the higher search score a search result has, the more highly the search result is related to the corresponding search criteria. Even if search results are the same, their search scores can change depending on search criteria. For example, the search score of an item A can be 40 for the keywords “digital camera”, and the search score of the item A can be 80 for the combination of the keywords “digital camera” and the category “compact digital cameras”. In both the first and second search results, a search result that is relatively highly related to corresponding search criteria is likely to be a representative search result matching the search criteria or a search result suitable to the search criteria. By comparing representative search results, a distinction of the second search results can be correctly identified.

FIGS. 7A to 7C are diagrams illustrating an example of how distinctive search results are extracted. FIG. 7A is a diagram illustrating example first and second search results. As illustrated in FIG. 7A, related search criteria are retrieved from the related search criteria DB 12c, based on given search criteria. First search results 51 are retrieved based on the given search criteria, and second search results 52 are retrieved based on the related search criteria. The second search results 52 are included among the first search results 51. FIG. 7B is a diagram illustrating example first and second comparison search results. Assume that the predetermined percentile is the 30th percentile. As illustrated in FIG. 7B, first comparison search results 53, which are search results, among the first search results 51, having a display rank between first and the rank corresponding to the 30th percentile inclusive, are placed in the lower part of the first search results 51. The first comparison search results 53 are in the top 30% of the first search results 51 in the display ranking. As illustrated in FIG. 7B, second comparison search results 54, which are search results, among the second search results 52, having a display rank between first and the rank corresponding to the 30th percentile inclusive, are placed in the right part of the second search results 52. The second comparison search results 54 are in the top 30% of the second search results 52 in the display ranking. As described above, even if items are the same, their search scores can change depending on search criteria. Thus, at least part of search results that have relatively high search scores among the second search results may not be included among search results that have relatively high search scores among the first search results. FIG. 7C is a diagram illustrating example distinctive search results. As illustrated in FIG. 7C, distinctive search results 55 are placed in part of the second comparison search results 54 where there is no overlap between the first comparison search results 53 and the second comparison search results 54. That is, the distinctive search results 55 are placed in the upper right part of the second comparison search results 54.

The generator 144 generates, for each set of related search criteria included among the plurality of sets of related search criteria retrieved by the related search criteria retriever 142, distinction information, based on item information about items included in the distinctive search results. For example, the generator 144 may generate distinction information including attribute values of the items included in the distinctive search results. The attribute values included in the distinction information may be, for example, a representative value of the attribute values of the items included in the distinctive search results. For example, the representative value may be the average value, the maximum value, the minimum value, the median value, the mode value, or the like. The number of attribute categories corresponding to the attribute values included in the distinction information may be one or more. The attribute categories corresponding to the attribute values included in the distinction information may be, for example, predetermined or determined based on categories of the items included in the distinctive search results by the generator 144. Also for example, the generator 144 may generate distinction information including details of reviews on the distinctive search results. It is possible that a review on an item is one attribute of the item. The attribute value in this case is a detail of the review. In this case, the generator 144 may perform, for example, a morphological analysis of details of reviews on each item included in the distinctive search results, to identify a trend in the reviews. The generator 144 may put words, phrases, or sentences indicating the trend in the distinction information, or may put details of one review following the trend in the distinction information.

Also for example, the generator 144 may extracts an item as a sample from among the distinctive search results. For example, the generator 144 may randomly extract a sample or extract a sample having an attribute closest to a representative value of attribute values of the distinctive search results. The generator 144 may then generate, for example, distinction information including at least one of the name and an image of the extracted sample and also including an attribute value of the sample or details of a review on the sample. Alternatively, the generator 144 may generate, for example, distinction information including at least one of the name and an image of the extracted sample and also including the representative value of the attribute values.

The provider 145 provides, for each set of related search criteria included among the plurality of sets of related search criteria retrieved by the related search criteria retriever 142, the related search criteria and the corresponding distinction information in association with each other to the user terminal 2. For example, the provider 145 may send a suggestion list to the user terminal 2. The suggestion list includes suggestion information for each set of related search criteria. The suggestion information includes the related search criteria and the corresponding distinction information. The user terminal 2 displays the suggestion list received from the online marketplace server 1. FIG. 8 is a diagram showing an example of the suggestion list that is displayed on the home page. As shown in FIG. 8, a suggestion list 210 is displayed, for example, immediately below the keyword entry field 111. In the example shown in FIG. 8, the suggestion list 210 includes five pieces of suggestion information 210-1 to 210-5. Each piece of suggestion information includes related search criteria 211 and distinction information 212. When a user selects one of the sets of related search criteria 211, the user terminal 2 sends a search request including the selected related search criteria 211 to the online marketplace server 1, and the online marketplace server 1 searches for items that match the related search criteria 211. The online marketplace server 1 then sends a resulting search result page to the user terminal 2. The distinction information 212 may include, for example, an item name 213 and attributes 214. The item name 213 is the name of an item extracted as a sample. When the user selects the item name 213 corresponding to one of the sets of related search criteria 211, for example, the online marketplace server 1 may send an item page for the item corresponding to the selected item name 213 to the user terminal 2. The attributes 214 indicate attributes that the sample has. The item name 213 and the attributes 214 are distinction information. No item name may be displayed in the suggestion list. The attributes 214 may be a representative value of attribute values that corresponding distinctive search results have.

FIG. 8 shows an example where the keywords “digital camera” are entered as given search criteria. For example, the related search criteria 211 of the suggestion information 210-1 are a combination of the keywords “digital camera” and the category “compact digital cameras”. For example, the related search criteria 211 of the suggestion information 210-2 are a combination of the keywords “digital camera” and the category “digital single-lens reflex cameras”. The related search criteria 211 of the suggestion information 210-3 are the keywords “digital camera waterproof”. The related search criteria 211 of the suggestion information 210-4 are the keywords “digital camera dustproof”. The related search criteria 211 of the suggestion information 210-4 are the keywords “digital camera for kids”. As the attributes 214, prices, the numbers of CCD pixels, waterproof capabilities, and weight are being displayed. As the attributes 214 of the suggestion information 210-1, “10000 yen”, “20 megapixels”, “water-resistant”, and “250 g” are being displayed. As the attributes 214 of the suggestion information 210-2, “50000 yen”, “40 megapixels”, “5 m water resistant”, and “350 g” are being displayed. As the attributes 214 of the suggestion information 210-3, “23000 yen”, “18 megapixels”, “10 m water resistant”, and “300 g” are being displayed. As the attributes 214 of the suggestion information 210-4, “25000 yen”, “15 megapixels”, “10 m water resistant”, and “300 g” are being displayed. As the attributes 214 of the suggestion information 210-5, “8000 yen”, “8 megapixels”, “no waterproof capability”, and “230 g” are being displayed. Different categories of second search results may be retrieved for different sets of related search criteria. In this case, for example, for each set of related search criteria, attribute values of the attribute category corresponding to its category may be displayed as the attributes 214.

The generator 144 may generate, for example, for each attribute category, distinction information including an attribute value range of the items included in the distinctive search results and also including the number of items that have attribute values in this range. Alternatively, the generator 144 may generate, for one attribute category, distinction information including a plurality of attribute value ranges of the items included in the distinctive search results and also including the number of items that have attribute values in each of the ranges. For example, a plurality of attribute value ranges are determined for each attribute category. The generator 144 may determine one or more attribute value ranges, based on the distribution of attribute values of the items included in the distinctive search results. Alternatively, the attribute value ranges may be predetermined for each attribute category. For example, assume that the number of items matching the related search criteria 211 of the suggestion information 210-2 is 500. The price range of these items is between 30000 yen and 60000 yen inclusive. The number of items whose number of pixels is 30 million or more and less than 40 million is 300, and the number of items whose number of pixels is 40 million or more but less than 50 million is 200. In this case, as information about prices and the numbers of pixels in the attributes 214 of the suggestion information 210-2, for example, “Price: 30000 to 60000 yen (500) Pixels: 30 to 40 megapixels (300)/40 to 50 megapixels (200)” may be displayed.

For each set of related search criteria included among the displayed plurality of sets of related search criteria, distinction information indicating a distinction of the second search results that are retrieved based on the related search criteria is displayed. Thus, the user can easily see differences between the first search results retrieved based on the given search criteria and each of the plurality of sets of second search results retrieved based on the plurality of sets of related search criteria. The user can easily see how differences between the first search results and the second search results change depending on the related search criteria. Thus, the user can select related search criteria appropriate for the user, based on the distinction information.

If second search results matching a set of related search criteria and second search results matching another set of related search criteria have a lot in common, the provider 145 may combine these sets of related search criteria. The provider 145 may then cause the user terminal 2 to display the combined related search criteria. For example, assume that second search results [1] are retrieved based on related search criteria [1] and that second search results [2] are retrieved based on related search criteria [2]. The provider 145 identifies overlaps between the second search results [1] and the second search results [2]. For example, when the proportion of the overlaps between the second search results [1] and the second search results [2] is greater than or equal to a predetermined percentage, the provider 145 combines the related search criteria [1] and the related search criteria [2]. Also when the proportion of overlaps among corresponding sets of second search results matching three or more sets of related search criteria is greater than or equal to a predetermined percentage, the provider 145 may combine these three or more sets of related search criteria. For example, when the proportion of overlaps among the second search results [1] to second search results [3] is greater than or equal to a predetermined percentage, the provider 145 combines the related search criteria [1] to related search criteria [3].

FIG. 9 is a diagram showing an example of the suggestion list that is displayed on the home page. FIG. 9 differs from FIG. 8 in that the suggestion information 210-3 and the suggestion information 210-4 are combined to generate new suggestion information 210-6. Specifically, the suggestion information 210-3 and 210-4 are being displayed in one area. By looking at the suggestion information 210-6, the user can see that there is not much difference between search results retrieved when the keywords “digital camera waterproof” are selected as related search criteria and search results retrieved when the keywords “digital camera dustproof” are selected as related search criteria.

When the user selects combined related search criteria from the suggestion list, the system controller 14 may search for items that match the logical OR of the combined related search criteria. For example, if the user selects the related search criteria 211 of the suggestion information 210-6 from the suggestion list shown in FIG. 9, the system controller 14 searches for items that match at least either the keywords “digital camera waterproof” or the keywords “digital camera dustproof”.

### 1-5. How Information Processing System Works

The following describes an operation of the information processing system S with reference to FIG. 10. FIG. 10 is a flowchart showing an example of a suggestion process in the system controller 14 of the online marketplace server 1 according to this embodiment. Every time a user enters a character in the keyword entry field 111 on the home page or a search results page, the user terminal 2 sends given search criteria with the user ID of the user to the online marketplace server 1. When receiving the given search criteria from the user terminal 2, the system controller 14 performs the suggestion process.

As shown in FIG. 10, the related search criteria retriever 142 retrieves related search criteria [1] to related search criteria [N] that correspond to the given search criteria from the related search criteria DB 12c (Step S1). N indicates the total number of sets of related search criteria. N is an integer greater than or equal to 2. Subsequently, the search unit 143 searches the item information DB 12b for the item IDs of items that match the given search criteria. The search unit 143 then retrieves first search results including the item IDs, the display ranks, and the search scores of the items matching the given search criteria (Step S2). Next, the generator 144 extracts, from among the first search results, search results having a display rank between first and a predetermined percentile rank inclusive, as first comparison search results (Step S3).

After that, the generator 144 sets a variable i to 1 (Step S4). The generator 144 also initializes a suggestion list. Subsequently, the generator 144 searches the item information DB 12b for the item IDs of items that match related search criteria [i]. The search unit 143 then retrieves second search results [i] including the item IDs, the display ranks, and the search scores of the items matching the given search criteria (Step S5). Next, the generator 144 extracts, from among the second search results [i], search results having a display rank between first and a predetermined percentile rank inclusive, as second comparison search results [i] (Step S6).

After that, the generator 144 extracts, from among the second comparison search results [i], search results that are not included among the first comparison search results, as distinctive search results [i] (Step S7). Subsequently, the generator 144 determines a sample of the distinctive search results [i] (Step S8). For example, the generator 144 may calculate, for each of the attribute categories of attributes that the distinctive search results [i] have, a representative value of attribute values therein. The generator 144 may then determine an item having attribute values closest to the representative values, among the distinctive search results [i], to be the sample, for example, using the least-squares method. Next, the generator 144 adds the related search criteria [i], the item name of the sample, and attribute values of the sample to the suggestion list (Step S9).

After that, the generator 144 determines whether the variable i is less than the total number N (Step S10). If the generator 144 determines that the variable i is less than the total number N (YES in Step S10), the process proceeds to Step S11. In Step S11, the generator 144 adds 1 to the variable i (Step S11), and the process proceeds to Step S5. On the other hand, if the generator 144 determines that the variable i is not less than the total number N (NO in Step S10), the process proceeds to Step S12. In Step S12, the provider 145 sends the suggestion list to the user terminal 2 and terminates the suggestion process. The user terminal 2 displays the suggestion list received from the online marketplace server 1 on the home page or the search results page.

As described above, according to this embodiment, the system controller 14 obtains given search criteria given by a user. The system controller 14 retrieves, from the storage unit 12, a plurality of sets of related search criteria that are related to the given search criteria. The system controller 14 also retrieves, from the storage unit 12, first search results including items matching the given search criteria. The system controller 14 also retrieves, for each set of related search criteria, second search results including items matching the related search criteria from the storage unit 12. The system controller 14 generates, for each set of related search criteria, distinction information that indicates a distinction of the second search results relative to the first search results, based on a comparison between the retrieved first search results and the retrieved second search results. The system controller 14 provides, for each set of related search criteria, the generated distinction information and the related search criteria in association with each other. Thus, by referring to the distinction information, the user can easily see differences between the first search results retrieved based on the given search criteria and each of the plurality of sets of second search results retrieved based on the plurality of sets of related search criteria. The user can also easily see how differences between the first search results retrieved based on the given search criteria and the second search results retrieved based on the related search criteria change depending on selection of the related search criteria.

### 2. Second Embodiment

### 2-1. Functional Overview of System Controller

The following describes a second embodiment. Except for points described below, the second embodiment is the same as the first embodiment. In this embodiment, the generator 144 extracts first comparison search results and second comparison search results, based on a user's operation logs on search results retrieved based on search criteria previously specified by the user. Specifically, based on the operation logs of the user of the user terminal 2 that has sent given search criteria, the generator 144 identifies the range of search results that can be viewed by the user, based on their display ranks. Based on the operation logs, the generator 144 identifies, for example, the display ranks of search results that were operated. Based on the identified display ranks, the generator 144 estimates the range of search objects that the user previously operated. The search results having the same display ranks as the search results that the user previously operated are likely to be viewed by the user. For example, assuming that first search results or second search results are displayed by the user terminal 2, the search results that can be viewed by the user are search results that the user is likely to view, among the first search results or the second search results. The generator 144 may identify one or more display ranks or may identify a display rank range. Search results that were operated by the user among the search results that were retrieved based on the search criteria previously specified by the user are search results that were viewed by the user. Thus, for example, the generator 144 may identify the display ranks of the search results that the user previously operated. The generator 144 extracts, from among the first search results, search results having the identified display ranks, as first comparison search results. The generator 144 extracts, from among the second search results, search results having the identified display ranks, as second comparison search results. Based on a comparison between the first comparison search results and the second comparison search results, the generator 144 generates distinction information that indicates a distinction of the second search results. The sets of search results, which the user is likely to view, are compared. Consequently, the provider 145 can provide distinction information more appropriate for the user.

For example, assume that the display rank of the search result having the lowest display rank, among the search results that were operated by the user, is the lowest operation rank. The operation performed by the user may be an operation for displaying an item page to be displayed or other operations. The generator 144 may identify a display rank range for search results to be viewed by the user, depending on the lowest operation rank. For example, the first rank to the lowest operation rank may be identified as the display rank range. The search results having a display rank between first to the lowest operation rank inclusive, among the search criteria previously specified by the user, are likely to have been viewed by the user. Thus, the user is also likely to view the search results having a display rank between first and the lowest operation rank inclusive, among the first search results. The same applies to the second search results. For example, the generator 144 may obtain, for each set of search criteria previously specified by the user, the display rank of the search result having the lowest display rank, among the search results that the user operated on the corresponding search results page. The generator 144 may then calculate a representative value of the obtained display ranks to be the lowest operation rank. The representative value in this case may be, for example, the average value, the minimum value, the maximum value, the median value, a predetermined percentile, or the like.

Also for example, the generator 144 may identify, as the display rank range, the first rank to the display rank of the search result having the lowest display rank, among the search results included in the same search results page as the search result having the lowest operation rank. Search results that were included in the same search results page as search results that were previously operated are likely to have been viewed by the user. For example, assume that one search results page displays ten search results. When the lowest operation rank is eighty-eighth, the search results to be viewed by the user range in display rank from the first to the ninetieth.

### 2-2. How Information Processing System Works

The following describes an operation of the information processing system S with reference to FIG. 11. FIG. 11 is a flowchart showing an example of the suggestion process in the system controller 14 of the online marketplace server 1 according to this embodiment. In FIG. 11, the same steps as in FIG. 10 are denoted by the same reference signs. As shown in FIG. 11, Steps S1 to S2 are performed. Subsequently, the generator 144 retrieves operation logs on search results pages, among the operation logs corresponding to the user ID received with the given search criteria from the user terminal 2, from the operation history DB 12e (Step S21). Next, the generator 144 identifies the lowest operation rank (Step S22). For instance, the generator 144 identifies, for each operation log, the display rank of the search result that was operated by the user, based on the operation position, the item ID, and the display rank included in the operation log. The generator 144 divides the operation logs into groups by search criteria previously specified. The generator 144 obtains, for each of the groups, the display rank of the search result having the lowest display rank, among the search results that were operated by the user. The generator 144 may calculates a representative value of the obtained display ranks to be the lowest operation rank. After that, the generator 144 extracts, from among the first search results, search results having a display rank of higher than or equal to the lowest operation rank, as first comparison search results (Step S23).

Subsequently, Steps S4 and S5 are performed. Next, the generator 144 extracts, from among the second search results [i], search results having a display rank of higher than or equal to the lowest operation rank, as second comparison search results [i] (Step S24). After that, Steps S7 to S10 are performed. If the variable i is less than the total number N (YES in Step S10), Step S11 is performed and the process returns to Step S5. If the variable i is not less than the total number N (NO in Step S10), Step S12 is performed and the suggestion process ends.

As described above, according to this embodiment, the system controller 14 retrieves first search results from which a display rank of each of search results included in the first search results can be identified and second search results from which a display rank of each of search results included in the second search results can be identified. The system controller 14 also retrieves, from the storage unit 12, user's operation logs on search results retrieved based on search criteria previously specified by the user from the storage unit 12. Based on the retrieved operation logs, the system controller 14 identify the display ranks of search results to be viewed by the user. The system controller 14 generates distinction information, based on a comparison between search results having the identified display ranks, among the first search results, and search results having the identified display ranks, among the second search results. The sets of search results, which the user is likely to view, are thus compared. Consequently, the information processing apparatus can provide distinction information more appropriate for the user.

The system controller 14 may identify a display rank range for search results to be viewed by the user, which depends on the lowest operation rank. The system controller 14 may generate distinction information, based on a comparison between search results having the display ranks within the identified range, among the first search results, and search results having the display ranks within the identified range, among the second search results. In this case, the range of search results that the user is likely to view is correctly identified. Consequently, the online marketplace server 1 can provide distinction information more appropriate for the user.

### 3. Third Embodiment

### 3-1. Functional Overview of System Controller

The following describes a third embodiment. Except for points described below, the third embodiment is the same as the first or second embodiment. In this embodiment, the generator 144 identifies, for each set of related search criteria, an attribute category that is among a plurality of attribute categories and in which the difference between an attribute value of items included in first search results and an attribute value of items included in second search results satisfies a predetermined condition, as a distinctive attribute category. For example, the generator 144 may identify an attribute category in which the difference is greater than or equal to a setting value. The setting value may be predetermined for each attribute category. Also for example, the generator 144 may identify an attribute category in which the ratio of the above-described difference to the attribute value of the items included in the first search results is higher than or equal to a setting percentage as a distinctive attribute category. Also for example, the generator 144 may identify an attribute category that is among the plurality of attribute categories and in which the ratio of the above-described difference to the attribute value of the items included in the first search results is highest, as a distinctive attribute category. The generator 144 includes, in distinction information, an attribute value that is among attribute values of the second search results and that corresponds to the identified distinctive attribute category. Thus, an attribute value of an attribute category in which there is a large difference in attribute values is provided. Consequently, a user can easily see, for each set of related search criteria, a distinctive attribute of the second search results relative to the first search results. The generator 144 may compare a representative value of the attribute values of the items included in the first search results with a representative value of the attribute values of the items included in the second search results. The representative value may be, for example, the average value, the minimum value, the maximum value, a predetermined percentile, the median value, the mode value, or the like.

The generator 144 may identify an attribute category in which the difference between an attribute value of items included in the first comparison search results and an attribute value of items included in the second comparison search results satisfies a predetermined condition, as a distinctive attribute category.

FIG. 12 is a diagram showing an example of how a distinctive attribute category is identified. For example, assume that there are four attribute categories: “price”, “CCD pixels”, “waterproof capability”, and “weight”. Also assume that the setting value for “price” is “10000 yen”, that the setting value for “pixels” is “10 megapixels”, that the setting value for “waterproof capability” is “2 ranks”, and that the setting value for “weight” is “100 g”. The waterproof capabilities are ranked in the order of “10 m water resistant”, “5 m water resistant”, “water-resistant”, and “no waterproof capability”. For example, assume that representative values of attribute values of items included in first search results matching the given search criteria “digital camera” are “25000 yen”, “20 megapixels”, “water-resistant”, and “300 g”. Also assume that representative values of items included in second search results matching the related search criteria “digital camera compact digital cameras” are “10000 yen”, “20 megapixels”, “water-resistant”, and “250 g”. In this case, “price” is a distinctive attribute category. Alternatively, assume that representative values of items included in second search results matching the related search criteria “digital camera digital single-lens reflex cameras” are “50000 yen”, “40 megapixels”, “5 m water-resistant”, and “350 g”. In this case, “price” and “pixels” are distinctive attribute categories. Alternatively, when representative values of items included in second search results matching the category “digital cameras waterproof” are “23000 yen”, “18 megapixels”, “10 m water-resistant”, and “300 g”, “waterproof capability” is a distinctive attribute category. Alternatively, when representative values of items included in second search results matching the category “digital cameras for kids” are “8000 yen”, “8 megapixels”, “no waterproof capability”, and “230 g”, “price” and “pixels” are distinctive attribute categories.

FIG. 13 is a diagram showing an example of the suggestion list that is displayed on the home page. FIG. 13 shows an example where the keywords “digital camera” are entered as given search criteria. As shown in FIG. 13, attribute value (s) corresponding to attribute category(ies) that are identified as distinctive attribute category(ies), among “price”, “CCD pixels”, “waterproof capability”, and “weight”, are displayed as attributes) 214 for each set of related search criteria. For example, as an attribute 214 of the suggestion information 210-1, “10000 yen” is displayed. As attributes 214 of the suggestion information 210-2, “50000 yen” and “40 megapixels” are displayed. As an attribute 214 of the suggestion information 210-3, “10 m” is displayed. As an attribute 214 of the suggestion information 210-4, “10 m” is displayed. As attributes 214 of the suggestion information 210-5, “8000 yen” and “8 megapixels” are displayed.

The generator 144 may include, as information indicating an attribute value that is among attribute values of the items included in the second search results and that corresponds to the distinctive attribute category, information indicating the inequality between a corresponding attribute value of the items included in the second search results and a corresponding attribute value of the items included in the first search results, in the distinction information. For example, if the attribute value of the items included in the second search results is larger than the attribute value of the items included in the first search results, the generator 144 may include, in the distinction information, the name of the distinctive attribute category and information indicating the inequality between the attribute values, such as “large”. If the attribute value of the items included in the second search results is smaller than the attribute value of the items included in the first search results, the generator 144 may include, in the distinction information, the name of the distinctive attribute category and information indicating an inequality between the attribute values, such as “small”. The user terminal 2 that has received the distinction information from the online marketplace server 1 displays, as the attributes 214, the name of the distinctive attribute category and information indicating the inequality, which are included in the distinction information. In this case, the user terminal 2 may display a character, a symbol, or an image corresponding to the information indicating the inequality.

FIG. 14 is a diagram showing an example of the suggestion list that is displayed on the home page. In FIG. 14, if an attribute value of the items included in the second search results is larger than an attribute value of the items included in the first search results, an arrow indicating the upward direction is displayed as information indicating the inequality between the attribute values. If the attribute value of the items included in the second search results is smaller than the attribute value of the items included in the first search results, an arrow indicating the downward direction is displayed as information indicating the inequality between the attribute values. In the example shown in FIG. 12, the distinctive attribute category of the second search results matching the related search criteria “digital camera compact digital cameras” is “price”. The price of the items in this second search results is lower than the price of the items included in the first search results matching the given search criteria “digital camera”. Thus, as shown in FIG. 14, a pair of “price” and an arrow indicating the downward direction is displayed as an attribute 214 of the suggestion information 210-1. The distinctive attribute categories of the second search results matching the related search criteria “digital camera digital single-lens reflex cameras” are “price” and “pixels”. The price of the items in this second search results is higher than the price of the items included in the first search results. The number of pixels of the items in this second search results is larger than the number of pixels of the items included in the first search results. Thus, as shown in FIG. 14, a pair of “price” and an arrow indicating the upward direction and a pair of “pixels” and an arrow indicating the upward direction are displayed as attributes 214 of the suggestion information 210-2. Similarly, a pair of “waterproof capability” and an arrow indicating the upward direction is displayed as an attribute 214 of the suggestion information 210-3 and as an attribute 214 of the suggestion information 210-4. A pair of “price” and an arrow indicating the downward direction and a pair of “pixels” and an arrow indicating the downward direction are displayed as attributes 214 of the suggestion information 210-5.

The generator 144 may include, in the distinction information, an attribute value corresponding to each of all distinctive attribute categories identified for a plurality of sets of related search criteria. This enables the user to easily see, across the plurality of sets of related search criteria, a distinctive attribute of the second search results relative to the first search results and to easily compare attributes of the second search results among the plurality of sets of related search criteria.

In the example shown in FIG. 12, “price”, “pixels”, and “waterproof capability” are each a distinctive attribute category for at least one of the plurality of sets of related search criteria. Thus, all distinctive attribute categories identified for the plurality of sets of related search criteria are “price”, “pixels” and “waterproof capability”. “Weight” is not a distinctive attribute category.

FIG. 15 is a diagram showing an example of the suggestion list that is displayed on the home page. FIG. 15 shows an example where the keywords “digital camera” are entered as given search criteria. As shown in FIG. 15, attribute values corresponding to “price”, “pixels”, and “waterproof capability”, among “price”, “pixels”, “waterproof capability”, and “weight”, are displayed as attributes 214 for each set of related search criteria. For example, as attributes 214 of the suggestion information 210-1, “10000 yen”, “20 megapixels”, and “water-resistant” are displayed. As attributes 214 of the suggestion information 210-2, “50000 yen”, “40 megapixels”, and “5 m water resistant” are displayed. As attributes 214 of the suggestion information 210-3, “23000 yen”, “18 megapixels”, and “10 m water resistant” are displayed. As attributes 214 of the suggestion information 210-4, “25000 yen”, “15 megapixels”, and “10 m water resistant” are displayed. As attributes 214 of the suggestion information 210-5, “8000 yen”, “8 megapixels”, and “none” are displayed.

The generator 144 may generate, for each set of related search criteria, distinction information so that an attribute value corresponding to the distinctive attribute category identified for the related search criteria will be displayed in a format different from attribute values corresponding to the other distinctive attribute categories. For example, the generator 144 may change the display formatting, such as the size, the thickness, the font style, or the color, of the attribute value. Also for example, the generator 144 may generate distinction information so that a predetermined image will be displayed over or near the attribute value corresponding to the distinctive attribute category. This enables the user to easily see, for each set of related search criteria, a distinctive attribute of the second search results relative to the first search results. FIG. 15 shows an example where, for each set of related search criteria, characters indicating an attribute value corresponding to the distinctive attribute category identified for the related search criteria are displayed larger than characters indicating attribute values corresponding to the other distinctive attribute categories. For example, among the attributes 214 of the suggestion information 210-1, “10000 yen” is displayed larger than “20 megapixels” and “water-resistant”.

### 3-2. How Information Processing System Works

The following describes an operation of the information processing system S with reference to FIG. 16. FIG. 16 is a flowchart showing an example of the suggestion process in the system controller 14 of the online marketplace server 1 according to this embodiment. In FIG. 16, the same steps as in FIG. 10 are denoted by the same reference signs. As shown in FIG. 16, Steps S1 to S8 are performed. Subsequently, the generator 144 identifies a distinctive attribute category that is among attribute categories corresponding to the second search results [i] and in which the difference between an attribute value of the first search results and an attribute value of the second search results [i] is greater than or equal to a setting value (Step S31). For example, the generator 144 calculates, for each attribute category, a representative value of the corresponding attribute values of the items included in the first search results. The generator 144 also calculates, for each attribute category, a representative value of the corresponding attribute values of the items included in the second search results [i]. The generator 144 also retrieves, for each attribute category, the setting value corresponding to the attribute category from the storage unit 12. The generator 144 identifies, as a distinctive attribute category, an attribute category in which the difference between the representative values of the attribute values is greater than or equal to the corresponding setting value. Next, the generator 144 adds the related search criteria [i], the item name of the sample, and an attribute value that is among attribute values of the sample and that corresponds to the distinctive attribute category, to the suggestion list (Step S32). After that, Step S10 is performed. If the variable i is less than the total number N (YES in Step S10), Step S11 is performed and the process returns to Step S5. If the variable i is not less than the total number N (NO in Step S10), Step S12 is performed and the suggestion process ends.

As described above, according to this embodiment, the system controller 14 identifies an attribute category that is among a plurality of attribute categories and in which the difference between an attribute value of search results included among first search results and an attribute value of search results included among second search results satisfies a predetermined condition. The system controller 14 includes, in distinction information, an attribute value that is among attribute values included in the second search results and that corresponds to the identified attribute category. Thus, the online marketplace server 1 can provide a distinctive attribute of the second search results relative to the first search results.

### 4. Fourth Embodiment

### 4-1. Functional Overview of System Controller

The following describes a fourth embodiment. Except for points described below, the fourth embodiment is the same as the first or second embodiment. In this embodiment, the generator 144 identifies, for each set of related search criteria, an attribute category that is among a plurality of attribute categories and in which the difference between the distribution of attribute values of search results included among second search results matching the related search criteria and the distribution of attribute values of search results included among second search results matching each of the other sets of related search criteria satisfies a predetermined condition, as a distinctive attribute category. The distribution of attribute values is, for example, a frequency distribution. The generator 144 includes, in distinction information, an attribute value that is among the attribute values of the second search results and that corresponds to the distinctive attribute category. An attribute category in which the distribution of attribute values of search results included among second search results matching a set of related search criteria differs greatly from the distribution of attribute values of search results included among second search results matching each of the other sets of related search criteria is likely to indicate a distinctive attribute that the second search results matching the related search criteria have. Thus, a user can easily see, for each set of related search criteria, a distinctive attribute of second search results matching the related search criteria compared with second search results matching each of the other sets of related search criteria. The generator 144 may identify an attribute category in which the difference between the distribution of attribute values of search results included among second comparison search results matching a set of related search criteria and the distribution of attribute values of search results included among second comparison search results matching each of the other sets of related search criteria satisfies a predetermined condition, as a distinctive attribute category.

For example, a plurality of attribute value ranges are determined for each attribute category. The attribute value ranges may be predetermined for each attribute category. The generator 144 may count, for each set of related search criteria, the number of search results that are among second search results matching the related search criteria and that have an attribute indicated by an attribute value in each attribute value range. The generator 144 may calculate, for each attribute category, the difference in the distribution of corresponding attribute values between sets of related search criteria, based on the number of search results counted for each attribute value range. When there is a relatively large difference between the distribution of attribute values of search results included among second search results matching a target set of related search criteria and the distribution of attribute values of search results included among second search results matching another set of related search criteria in a target attribute category, the generator 144 may determine the target attribute category to be a distinctive attribute category of the second search results matching the target set of related search criteria.

FIG. 17 is a diagram showing an example of how a distinctive attribute category is identified. For example, assume that there are three attribute categories: “price”, “CCD pixels”, and “weight”. Also assume that there are three sets of related search criteria 1 to 3. The number of second search results matching the related search criteria 1 is 2000. The number of second search results matching the related search criteria 2 is 2200. The number of second search results matching the related search criteria 3 is 1600.

There are three price ranges: 10000 yen or less, 10001 yen or more and 20000 yen or less, and 20001 yen or more. In the range of 10000 yen or less, the number of second search results matching the related search criteria 1 is 1300, the number of second search results matching the related search criteria 2 is 500, and the number of second search results matching the related search criteria 3 is 500. In the range of 10001 yen or more and 20000 yen or less, the number of second search results matching the related search criteria 1 is 400, the number of second search results matching the related search criteria 2 is 900, and the number of second search results matching the related search criteria 3 is 600. In the range of 20001 yen or more, the number of second search results matching the related search criteria 1 is 400, the number of second search results matching the related search criteria 2 is 900, and the number of second search results matching the related search criteria 3 is 600. Obviously, in the range of 10000 yen or less, there is a large difference between the number of second search results matching the related search criteria 1 and the number of second search results matching each of the other sets of related search criteria. The generator 144 may calculate the difference between the distribution of prices of the second search results matching the related search criteria 1 and the distribution of prices of the second search results matching each of the other sets of related search criteria, for example, using the following equation.

ABS(1300−500)+ABS(1300−500)+ABS(400−900)+ABS(400−600)+ABS(300−800)+ABS(300−500)=3000

ABS(x) is a function that indicates the absolute value of x. Similarly, for the related search criteria 2 and for the related search criteria 3, the generator 144 calculates the difference in the distribution of prices. For the related search criteria 2, the difference in the distribution of prices is 2400. For the related search criteria 2, the difference in the distribution of prices is 1800. The generator 144 determines “price” to be a distinctive attribute category of the second search results matching the related search criteria 1, which is the largest in the calculated difference in the distribution of prices, among the sets of related search criteria 1 to 3.

Similarly, for “pixels” and for “weight”, the generator 144 calculates the difference in the number of second search results. Consequently, the generator 144 determines “pixels” to be a distinctive attribute category of the second search results matching the related search criteria 2, which are the largest in the calculated difference in the number of second search results, among the sets of related search criteria 1 to 3. The generator 144 also determines “weight” to be a distinctive attribute category of the second search results matching the related search criteria 3, which are the largest in the calculated difference in the number of second search results, among the sets of related search criteria 1 to 3.

### 4-2. How Information Processing System Works

Next, an operation of the information processing system S will be described with reference to FIGS. 18 and 19. FIGS. 18 and 19 is a flowchart showing an example of the suggestion process in the system controller 14 of the online marketplace server 1 according to this embodiment. In FIGS. 18 and 19, the same steps as in FIG. 10 are denoted by the same reference signs. As shown in FIG. 18, Steps S1 to S8 are performed. After that, Step S10 is performed. If the variable i is less than the total number N (YES in Step S10), Step S11 is performed and the process returns to Step S5.

If the variable i is not less than the total number N (NO in Step S10), the generator 144 sets a variable j to 1 as shown in FIG. 19 (Step S41). Subsequently, the generator 144 identifies an attribute category [j] among the attribute categories corresponding to the second search results [1] to [N]. Next, the generator 144 calculates, for each attribute value range of the identified attribute category [j], the number of each set of second search results [1] to [N]. The generator 144 then calculates, for each attribute value range, the difference in the number of search results between each pair of sets of second search results included among the second search results [1] to [N]. The generator 144 then calculates, for each set of second search results [1] to [N], the sum total of the differences in the number of search results between this set of second search results and the other sets of second search results (Step S42). After that, the generator 144 determines the attribute category [j] to be a distinctive attribute category of the second search results that are the largest in the sum total of the differences in the number of search results, among the second search results [1] to [N] (Step S43). Subsequently, the generator 144 determines whether the variable j is less than M that is the total number of attribute categories corresponding to the second search results [1] to [N] (Step S44). If the generator 144 determines that the variable j is less than the total number M (YES in Step S44), the process proceeds to Step S45. In Step S45, the generator 144 adds 1 to the variable j, and the process proceeds to Step S42. On the other hand, if the generator 144 determines that the variable j is not less than the total number M (NO in Step S44), the process proceeds to Step S46. In Step S46, the generator 144 sets the variable i to 1. Next, the generator 144 adds the related search criteria [i], the item name of the sample, and an attribute value that is among attribute values of the sample and that corresponds to the attribute category determined to be the distinctive attribute category of the second search results [i], to the suggestion list (Step S47). The generator 144 then determines whether the variable i is less than the total number N (Step S48). If the generator 144 determines that the variable i is less than the total number N (YES in Step S48), the process proceeds to Step S49. In Step S49, the generator 144 adds 1 to the variable i, and the process proceeds to Step S47. On the other hand, if the generator 144 determines that the variable i is not less than the total number N (NO in Step S48), the process proceeds to Step S12. In Step S12, the provider 145 sends the suggestion list to the user terminal 2 and terminates the suggestion process.

As described above, according to this embodiment, the system controller 14 identifies, for each set of related search criteria, an attribute category that is among a plurality of attribute categories and in which the difference between the distribution of attribute values of search results included among second search results matching the related search criteria and the distribution of attribute values of search results included among second search results matching each of the other sets of related search criteria satisfies a predetermined condition. The system controller 14 includes, in distinction information, an attribute value that is among the attribute values included in the second search results and that corresponds to the identified attribute category. Thus, the online marketplace server 1 can provide a distinctive attribute of the second search results relative to the other sets of second search results.

### 5. Fifth Embodiment

### 5-1. Functional Overview of System Controller

The following describes a fifth embodiment. Except for points described below, the fifth embodiment is the same as the first to fourth embodiments. In this embodiment, the generator 144 determines whether given search criteria correspond to at least one of a plurality of attribute categories, based on attribute values stored in the item DB 12b. If the given search criteria correspond to at least one attribute category, the generator 144 identifies the at least one attribute category as a distinctive attribute category. The generator 144 then includes, in distinction information, an attribute value that is among attribute values of second search results and that corresponds to the distinctive attribute category. A user sometimes enters, as at least one of the given search criteria, an attribute value that the user desires for a distinctive attribute category in which the user is interested. The attribute category corresponding to the attribute value entered by the user is an attribute category that is among the plurality of attribute categories and in which the user is interested. Thus, the user can compare, among a plurality of sets of related search criteria, an attribute that is among the attributes of the second search results and in which the user is interested.

For example, the attribute category corresponding to an attribute value matching keywords that the user in the keyword entry field 111 may be an attribute category matching the given search criteria. For example, assume that the user enters the keyword “1000”. In this case, for example, a price attribute value of “1000 yen”, a pixels attribute value of “10 megapixels”, and a weight attribute value of “1000 g” match this keyword. Ten million is written in Japanese as “1000 man”. Also for example, assuming that the user enters the keyword “water-resistant”, only a waterproof capability attribute value of “water-resistant” matches this keyword.

When searching the item DB 12b for attribute values that match the given search criteria, the generator 144 may search for attribute values that match the given search criteria, for example, from among the attribute values of all items. Alternatively, the generator 144 may search for attribute values that match the given search criteria, for example, from among the attribute values of first search results and all sets of second search results. Alternatively, the generator 144 may search for attribute values that match the given search criteria from among the attribute values of all sets of second search results. Alternatively, the generator 144 may search, for each set of related search criteria, for attribute values that match the given search criteria from among the attribute values of second search results matching the related search criteria.

FIG. 20 is a diagram showing an example suggestion list displayed on a search results page. FIG. 20 is a search results page showing search results obtained when the category “compact digital cameras” are specified as search criteria on the home page. At this point, a user enters “digital camera 1000” in the keyword entry field 111. Thus, given search criteria include the keywords “digital camera 1000” and the category “compact digital cameras”. The suggestion list 210 shown in FIG. 20 includes suggestion information 210-1 to 210-3. The related search criteria of the suggestion information 210-1 are the keywords “digital camera 1000 yen”. The related search criteria of the suggestion information 210-2 are the keywords “digital camera 1000 g”. The related search criteria of the suggestion information 210-3 are the keywords “digital camera 10000 yen”. From among attribute values of second search results matching the related search criteria of the suggestion information 210-1, “1000 yen” and “1000 g” have been retrieved as attribute values that match the keyword “1000”. Thus, as attributes 214 of the suggestion information 210-1, a price and a weight are displayed. From among attribute values of second search results matching the related search criteria of the suggestion information 210-2, “1000 g” has been retrieved as an attribute value that matches the keyword “1000”. Thus, as an attribute 214 of the suggestion information 210-2, a weight is displayed. From among attribute values of second search results matching the related search criteria of the suggestion information 210-3, “1000 g” has been retrieved as an attribute value that matches the keyword “1000”. Thus, as an attribute 214 of the suggestion information 210-3, a weight is displayed. Assume that an attribute value of “digital camera” does not exist.

### 5-2. How Information Processing System Works

The following describes an operation of the information processing system S with reference to FIG. 21. FIG. 21 is a flowchart showing an example of the suggestion process in the system controller 14 of the online marketplace server 1 according to this embodiment. In FIG. 21, the same steps as in FIG. 10 are denoted by the same reference signs. As shown in FIG. 21, Steps S1 to S8 are performed. Subsequently, the generator 144 searches the item DB 12b for attribute values that match the given search criteria (Step S51). For example, the generator 144 may search, for each keyword included in the given search criteria, for attribute values that match the keyword from among attribute values corresponding to the second search results [i]. Next, the generator 144 determines whether any attribute values matching the given search criteria have been found (Step S52). If the generator 144 determines that no attribute value matching the given search criteria has been found (NO in Step S52), the process proceeds to Step S9. In Step S9, the generator 144 adds the related search criteria [i], the item name of the sample, and attribute values of the sample to the suggestion list, and the process proceeds to Step S10. On the other hand, if the generator 144 determines that an attribute value matching the given search criteria has been found (YES in Step S52), the process proceeds to Step S53. In Step S53, the generator 144 determines the attribute category corresponding to the found attribute value to be a distinctive attribute category. Subsequently, the generator 144 adds the related search criteria [i], the item name of the sample, and an attribute value that is among attribute values of the sample and that corresponds to the identified distinctive attribute category, to the suggestion list (Step S54). After that, the generator 144 performs Step S10. If the variable i is less than the total number N (YES in Step S10), Step S11 is performed and the process returns to Step S5. If the variable i is not less than the total number N (NO in Step S10), Step S12 is performed and the suggestion process ends.

As described above, according to this embodiment, if it is determined based on attribute values stored in the storage unit 12 that given search criteria correspond to at least one of a plurality of attribute categories, the system controller 14 identifies the at least one attribute category. The system controller 14 includes, in distinction information, an attribute value that is among attribute values corresponding to second search results and that corresponds to the identified attribute category. Thus, the online marketplace server 1 can provide, as a distinction of the second search results, an attribute value corresponding to an attribute category in which a user is interested.

### 6. Sixth Embodiment

### 6-1. Functional Overview of System Controller

The following describes a sixth embodiment. Except for points described below, the sixth embodiment is the same as the first to fifth embodiments. In this embodiment, the generator 144 identifies, for each set of related search criteria, search results that are included among both first and second search results and whose search scores based on the related search criteria are higher than their search scores based on given search criteria, as distinctive search results. The generator 144 then generates distinction information that indicates a distinction of the distinctive search results. As described above, even if search results are the same, their search scores can change depending on search criteria. Search results that are more highly related to the related search criteria than to the given search criteria are expected to be distinctive search results of the second search results relative to the first search results or representative search results. A user can see, for each set of related search criteria, a distinction of search results that are more highly related to the related search criteria than to the given search criteria.

FIGS. 22A and 22B are diagrams illustrating an example of how distinctive search results are extracted. FIG. 22A is a diagram illustrating example first and second search results. As illustrated in FIG. 22A, second search results 62 are included among first search results 61. FIG. 22B is a diagram illustrating example distinctive search results. As illustrated in FIG. 22B, the search results included among second search results are divided into search results 63, whose search scores based on related search criteria are less than or equal to their search scores based on given search criteria, and search results 64, whose search scores based on the related search criteria are higher than their search scores based on the given search criteria. The generator 144 identifies the search results 64 as distinctive search results.

For example, the generator 144 may identify, as distinctive search results, search results whose difference between their search scores based on the related search criteria and their search scores based on the given search criteria is greater than or equal to a predetermined difference. Also for example, the generator 144 may identify, as distinctive search results, search results whose ratio of their search scores based on the related search criteria to their search scores based on the given search criteria is greater than or equal to a predetermined percentage.

### 6-2. How Information Processing System Works

The following describes an operation of the information processing system S with reference to FIG. 23. FIG. 23 is a flowchart showing an example of the suggestion process in the system controller 14 of the online marketplace server 1 according to this embodiment. In FIG. 23, the same steps as in FIG. 10 are denoted by the same reference signs. As shown in FIG. 23, Steps S1 and S2 are performed, and then Steps S4 and S5 are performed. Subsequently, the generator 144 identifies search results that are included among both the first and second search results [i], as common search results (Step S61). Next, the generator 144 extracts, from among the common search results, search results whose search scores based on the related search criteria [i] are higher than their search scores based on the given search criteria, as distinctive search results [i] (Step S62). After that, Steps S8 to S10 are performed. If the variable i is less than the total number N (YES in Step S10), Step S11 is performed and the process returns to Step S5. If the variable i is not less than the total number N (NO in Step S10), Step S12 is performed and the suggestion process ends.

As described above, according to this embodiment, the system controller 14 obtains a relationship of each search result included among first search results to given search criteria. The system controller 14 also obtains a relationship of each search result included among second search results to related search criteria. The system controller 14 generates distinction information that indicates a distinction of search results that are included among both the first and second search results and whose relationships to the related search criteria are higher than their relationships to the given search criteria. Thus, the online marketplace server 1 can provide a distinction of search results that are among the second search results and more highly related to the related search criteria.

### 7. Seventh Embodiment

### 7-1. Functional Overview of System Controller

The following describes a seventh embodiment. Except for points described below, the seventh embodiment is the same as the first to sixth embodiments. In the first to sixth embodiments, when providing a plurality of sets of related search criteria that are related to given search criteria to the user terminal 2, the system controller 14 provides distinction information that indicates a distinction of second search criteria retrieved based on each set of related search criteria. In this embodiment, the system controller 14 retrieves, from among sets of search criteria previously specified by a user who has given given search criteria, related search criteria that are related to the given search criteria. The system controller 14 then provides, to the user terminal 2, distinction information that indicates a distinction of second search criteria retrieved based on the given search criteria relative to first search criteria retrieved based on the related search criteria.

FIG. 24 is a diagram showing example functional blocks of the system controller 14 of the online marketplace server 1 according to this embodiment. In FIG. 24, the same components as in FIG. 6 are denoted by the same reference signs. As shown in FIG. 24, the e-commerce management program and other programs, which are read and executed by the CPU 14a, enable the system controller 14 to function as, for example, the given search criteria obtainer 141, the related search criteria retriever 142, the search unit 143, the generator 144, the provider 145, and a selection criteria identification unit 146. The selection criteria identification unit 146 is an example of operation log retrieval means and selection criteria identifying means of the present invention.

The given search criteria obtainer 141 obtains given search criteria. The given search criteria obtainer 141 obtains them in the same manner as in the first embodiment.

The related search criteria retriever 142 retrieves related search criteria that are related to the given search criteria obtained by the given search criteria obtainer 141 from the search history of the user who has given the given search criteria. That is, the related search criteria retriever 142 retrieves, from among sets of search criteria previously specified by the user who has given the given search criteria, related search criteria that are related to the given search criteria. For example, the related search criteria retriever 142 may retrieve, from the related search criteria DB 12c, all sets of search criteria that are related to the given search criteria as sets of candidate related search criteria. The related search criteria retriever 142 searches the search history DB 12d for search logs that are among the search logs that correspond to a user ID received with the given search criteria and that include search criteria matching at least one of the sets of candidate related search criteria. The related search criteria retriever 142 may obtain search criteria as related search criteria, for example, from the search log whose search date and time is latest among the retrieved search logs.

Based on the related search criteria obtained by the related search criteria retriever 142, the search unit 143 retrieves, from the item DB 12b, first search results including items matching the related search criteria. Based on the given search criteria obtained by the given search criteria obtainer 141, the search unit 143 also retrieves, from the item DB 12b, second search results including items matching the given search criteria. This embodiment differs from the first embodiment in that the first search results are retrieved based on the related search criteria, and that the second search results are retrieved based on the given search criteria. In the other respects, the first search results and the second search results are retrieved in the same manner as in the first embodiment.

The selection criteria identification unit 146 retrieves operation logs that are among the operation logs of the user who has entered the given search criteria and that correspond to the related search criteria from the operation history DB 12e. Based on the retrieved operation logs, the selection criteria identification unit 146 then identifies selection criteria. The selection criteria are criteria that the user is likely to have been considering as criteria for selecting an item from among search results. For example, based on the retrieved operation logs, the selection criteria identification unit 146 may identify, as selection criteria, the attribute range of an item that the user operated on a search results page. The operation performed by the user may be an operation for displaying an item page to be displayed or other operations.

For example, assume that search results include items with a 5- to 50-megapixel CCD. If a user causes only item pages for items with between 30 megapixels and 50 megapixels to be displayed, the selection criteria identification unit 146 may determine the number of pixels “30 or more megapixels” to be selection criteria. Also assume that there is an attribute category of “maker” and that search results include items made by a company a, items made by a company b, and items made by a company c. Among the items for which the user caused item pages to be displayed, the proportion of items made by the company a and the proportion of items made by the company b are each greater than or equal to a predetermined percentage, and the proportion of items made by the company c is less than the predetermined percentage. In this case, the selection criteria identification unit 146 may determine the maker “company a or company b” to be selection criteria. For example, the selection criteria identification unit 146 may determine selection criteria only for one attribute category or may determine selection criteria for a plurality of attribute categories.

The generator 144 extracts, from among the first search results, search results identified based on the operation logs retrieved by the selection criteria identification unit 146, as first comparison search results. For example, the generator 144 may extract, from among the first search results, search results matching the selection criteria identified by the selection criteria identification unit 146, as first comparison search results. Alternatively, the generator 144 may extract, from among the first search results, search results operated on the search results page, as first comparison search results.

The generator 144 also extracts, from among the second search results, search results matching the selection criteria identified by the selection criteria identification unit 146, as second comparison search results.

Based on a comparison between the first comparison search results and the second comparison search results, the generator 144 generates distinction information that indicates a distinction of the second comparison search results relative to the first comparison search results. For example, the generator 144 may extract distinctive search results from among the second comparison search results and generate distinction information that indicates a distinction of the distinctive search results. The sets of search results matching criteria that the user is likely to have been considering are compared. Consequently, the provider 145 can provide distinction information more appropriate for the user.

FIGS. 25A to 25D are diagrams illustrating an example of how distinctive search results are extracted. FIG. 25A is a diagram illustrating example first and second search results. As illustrated in FIG. 25A, related search criteria are retrieved from the search history DB 12d, based on given search criteria. First search results 71 are retrieved based on the related search criteria, and second search results 72 are retrieved based on the given search criteria. The second search results 72 are included among the first search results 71. FIG. 25B is a diagram illustrating example first and second interim search results. As illustrated in FIG. 25B, search results that are identified based on operation logs, among the first search results 71, are first interim search results 73. Among the second search results 72, search results that are identified based on selection criteria are second interim search results 74. FIG. 25C is a diagram illustrating example first and second comparison search results. As illustrated in FIG. 25C, search results that are the first interim search results 73 having a display rank between first and the rank corresponding to the 30th percentile inclusive are extracted as first comparison search results 75. Search results that are the second interim search results 74 having a display rank between first and the rank corresponding to the 30th percentile inclusive are extracted as second comparison search results 76. FIG. 25D is a diagram illustrating example distinctive search results. As illustrated in FIG. 25D, distinctive search results 77 are part of the second comparison search results 76 where there is no overlap between the first comparison search results 75 and the second comparison search results 76.

For example, the generator 144 may extract, from among the first interim search results, search results with a predetermined score or higher as first comparison search results, and may extract, from among the second interim search results, search results with a predetermined score or higher as second comparison search results. Also for example, the generator 144 may identify the display ranks of search results to be viewed by the user, as in the second embodiment. The generator 144 may then extract, from among the first interim search results, search results with the identified display ranks as first comparison search results, and may extract, from among the second interim search results, search results with the identified display ranks as second comparison search results. Also for example, the generator 144 may extract, as distinctive search results, search results that are included among both the first and second interim search results and whose search scores based on the given search criteria are higher than their search scores based on the results of the search, as in the sixth embodiment. Whereas the generator 144 in the sixth embodiment extracts search results whose search scores on the related search criteria is higher, the generator 144 in this embodiment extracts search results whose search scores on the given search criteria is higher. This embodiment differs from the sixth embodiment in this respect.

The generator 144 may extract first interim search results from among the first search results in the above-described manner, and then extract, as first comparison search results, search results identified based on the operation logs from among the first interim search results. The generator 144 may also extract second interim search results from among the second search results in the above-described manner, and then extract, from among the second interim search results, search results identified based on the operation logs, as second comparison search results.

The generator 144 generates distinction information, based on item information about items included in the distinctive search results. The distinction information may be generated in the same manner as in the first embodiment. For example, as in the third embodiment, the generator 144 may identify an attribute category that is among a plurality of attribute categories and in which the difference between an attribute value of items included in the first comparison search results and an attribute value of items included in the second comparison search results satisfies a predetermined condition, as a distinctive attribute category. Also for example, as in the fifth embodiment, if the given search criteria correspond to at least one attribute category, the generator 144 may identify the at least one attribute category as a distinctive attribute category. The generator 144 may then generate distinction information including an attribute value that corresponds to the distinctive attribute category among the plurality of attribute categories.

The provider 145 provides the distinction information generated by the generator 144 to the user terminal 2. The user terminal 2 displays the distinction information received from the online marketplace server 1. FIG. 26 is a diagram showing example distinction information displayed on a search results page. FIG. 26 is a search results page showing search results obtained when a combination of the keywords “digital camera” and the category “compact digital cameras” is specified as search criteria on the home page. At this point, a user adds “waterproof” in the keyword entry field 111. Thus, the given search criteria obtainer 141 retrieves the keywords “digital camera waterproof” and the category “compact digital cameras” as given search criteria. The related search criteria retriever 142 retrieves, for example, the most recently specified keywords “digital camera” and the category “compact digital cameras” as related search criteria from the search history DB 12d. The search unit 143 retrieves first search results, based on the related search criteria, and retrieves second search results, based on the given search criteria. The generator 144 generate distinction information and sends it to the user terminal 2. The user terminal 2 displays distinction information 410 on the search results page. For example, the user terminal 2 may display the distinction information 410 over or near the search criteria specification area 110. The distinction information 410 may include, for example, an item name 411 and attributes 412. The item name 411 may be the item name of a sample that is among second search results. The attributes 412 may be, for example, representative values of attribute values of the second search results or attribute values of the sample.

### 7-2. How Information Processing System Works

The following describes an operation of the information processing system S with reference to FIG. 27. FIG. 27 is a flowchart showing an example of a distinction information provision process in the system controller 14 of the online marketplace server 1 according to this embodiment. Every time a user enters a character in the keyword entry field 111 on the home page or a search results page, the user terminal 2 sends given search criteria with the user ID of the user to the online marketplace server 1. When receiving the given search criteria from the user terminal 2, the system controller 14 performs the distinction information provision process.

As shown in FIG. 27, the related search criteria retriever 142 retrieves search logs that correspond to the user ID received from the user terminal 2 from the search history DE 12d (Step S81). Subsequently, the related search criteria retriever 142 obtains, from among the retrieved search logs, related search criteria that are related to the given search criteria (Step S82). If there are a plurality of search logs including the related search criteria, the related search criteria retriever 142 obtains related search criteria, for example, from the search log whose search date and time is latest among these search logs.

Next, the generator 144 retrieves operation logs on search results retrieved based on the obtained related search criteria, from the operation history DB 12e (Step S83). For example, the generator 144 retrieves operation logs including both the user ID received from the user terminal 2 and the obtained related search criteria.

Subsequently, based on the retrieved operation logs, the generator 144 determines selection criteria (Step S84). For example, the generator 144 obtains search results from the search log from which the related search criteria has been obtained. The generator 144 obtains the item IDs of found items from among the search results, and retrieves item information corresponding to the item IDs form the item DB 12b. Next, based on operation positions included in operation logs on search results pages and on operation logs on item pages, the generator 144 obtains, from among the search results retrieved based on the related search criteria, the item IDs of items for which item pages were displayed in response to the user's selections. After that, based on the item information, the generator 144 identifies, for each attribute category, the attribute value range of all the search results. The generator 144 also identifies the attribute value range of the items for which item pages were displayed. The generator 144 identifies an attribute category in which the attribute value range of all the search results is different from the attribute value range of the items for which item pages were displayed. The generator 144 determines, in the identified attribute category, the attribute range of the items for which item pages were displayed to be selection criteria.

Subsequently, the search unit 143 searches the item information DB 12b for the item IDs of items that match the related search criteria to retrieve first search results (Step S85). Next, the generator 144 extracts, from among the first search results, search results matching the selection criteria, as first interim search results (Step S86). After that, the generator 144 extracts, from among the first interim search results, search results having a display rank between first and a predetermined percentile rank inclusive, as first comparison search results (Step S87).

Subsequently, the search unit 143 searches the item information DB 12b for the item IDs of items that match the given search criteria to retrieve second search results (Step S88). Next, the generator 144 extracts, from among the second search results, search results matching the selection criteria, as second interim search results (Step S89). After that, the generator 144 extracts, from among the second interim search results, search results having a display rank between first and a predetermined percentile rank inclusive, as second comparison search results (Step S90).

Subsequently, the generator 144 extracts, from among the second comparison search results, search results that are not included among the first comparison search results, as distinctive search results (Step S91). The generator 144 then determines a sample of the distinctive search results (Step S92). Next, the generator 144 generates distinction information including both the item name of the sample and attribute values of the sample (Step S93). After that, the generator 144 sends the generated distinction information to the user terminal 2 (Step S94), and terminates the distinction information provision process. The user terminal 2 displays the distinction information received from the online marketplace server 1 on the home page or the search results page.

As described above, according to this embodiment, the system controller 14 obtains given search criteria given by a user. The system controller 14 retrieves, from the storage unit 12, search criteria that are related to the given search criteria, as related search criteria. The system controller 14 also retrieves, from the storage unit 12, first search results including items matching the related search criteria. The system controller 14 also retrieves, from the storage unit 12, second search results including items matching the given search criteria. The system controller 14 also retrieves, from the storage unit 12, operation logs corresponding to the related search criteria. Based on the obtained operation logs, the system controller 14 identifies selection criteria. First comparison search results are among the first search results and identified based on the obtained operation logs. Second comparison search results are among the second search results and match the identified selection criteria. Based on a comparison between the first comparison search results and the second comparison search results, the system controller 14 generates distinction information that indicates a distinction of the second comparison search results. The system controller 14 then provides the generated distinction information. Thus, by referring to the distinction information, the user can easily see a difference between search results retrieved based on related search criteria previously specified and search results retrieved based on search criteria given later, under criteria that the user is considering.

### 8. Eighth Embodiment

### 8-1. Functional Overview of System Controller

The following describes an eighth embodiment. Except for points described below, the eighth embodiment is the same as the seventh embodiment. In this embodiment, the generator 144 retrieves display logs of attribute values of items based on a user's operations on first search results from the operation history DB 12e. Based on the retrieved logs, the generator 144 identifies the attribute category corresponding to a displayed attribute value as a distinctive attribute category. The generator 144 then includes, in distinction information, an attribute value that is among attribute values of second search results and that corresponds to the identified distinctive attribute category. The attribute category corresponding to an attribute value viewed by a user is an attribute category in which the user is likely to be interested. Displaying distinction information including an attribute value corresponding to a distinctive attribute category enables a user to easily see a difference between first search results and second search results, in an attribute in which the user is interested.

The generator 144 may determine a distinctive attribute category, for example, based on the proportion of the displayed attribute value. For example, based on operation logs on item pages and operation logs on review pages, the generator 144 may calculate the total display duration of item pages and review pages. Based on display ranges included in the operation logs on item pages, the generator 144 calculates how many hours which attribute category's attribute values in information contained in the item pages were displayed. The generator 144 calculates, for each attribute category, the proportion of the display duration of corresponding attribute values in the total display duration. The generator 144 determines an attribute category whose proportion of the display duration is greater than or equal to a predetermined percentage to be a distinctive attribute category. If the proportion of the display duration of review pages in the total display duration is greater than or equal to a predetermined percentage, the generator 144 determines “review” to be a distinctive attribute category. The generator 144 may determine one distinctive attribute category or may determine a plurality of distinctive attribute categories.

Also for example, the system controller 14 may generate a search result page so that the user can select an attribute category that is among a plurality of attribute categories and whose attribute value is displayed in each item information area 311 on the search results page. The system controller 14 also stores such selection of an attribute category as an operation log in the operation history DB 12e. Based on the operation log, the generator 144 determines the attribute category selected by the user to be a distinctive attribute category. For example, assume that from among the price, the number of pixels, the waterproof capability, and the weight of an item in the category of digital cameras, the user selects the price. The system controller 14 then sends, to the user terminal 2, a search results page containing an item information area 311 including only the price, among the price, the number of pixels, the waterproof capability, and the weight. In this case, the generator 144 determines “price” to be a distinctive attribute category.

### 8-2. How Information Processing System Works

The following describes an operation of the information processing system S with reference to FIG. 28. FIG. 28 is a flowchart showing an example of the distinction information provision process in the system controller 14 of the online marketplace server 1 according to this embodiment. In FIG. 28, the same steps as in FIG. 27 are denoted by the same reference signs. As shown in FIG. 28, Steps S81 to S92 are performed. Subsequently, the generator 144 identifies the attribute category corresponding to a displayed attribute value as a distinctive attribute category, based on display logs of attribute values of items corresponding to the first search results, among the operation logs retrieved in Step S83 (Step S101). For example, the generator 144 extracts, from among the retrieved operation logs, operation logs including the web page type of “item page” or “review page”. Next, the generator 144 calculates the total of display durations included in the extracted operation logs. After that, based on display ranges included in the operation logs on item pages and on HTML documents of the item pages, the generator 144 calculates what range of information contained in the item pages was actually displayed by the user terminal 2. The generator 144 also determines whether any attribute values are contained in the identified range. If an attribute value is contained, the generator 144 identifies the attribute category corresponding to the attribute value. The generator 144 then determines a display duration included in a corresponding operation log to be the display duration of an attribute value of the identified attribute category. The generator 144 calculates, for each attribute category, the total display duration of corresponding attribute values. Subsequently, the generator 144 calculates, for each attribute category, the proportion of the display duration of attribute values corresponding to the attribute category in the total display duration of item pages and review pages. The generator 144 determines an attribute category whose proportion of the display duration is greater than or equal to a predetermined percentage to be a distinctive attribute category. The generator 144 also calculates the total of display durations included in the operation logs on review pages. Subsequently, the generator 144 calculates the proportion of the display duration of review pages in the total display duration of item pages and review pages. If the proportion of the display duration is greater than or equal to a predetermined percentage, the generator 144 determines “review” to be a distinctive attribute category. Next, the generator 144 generates distinction information including both the item name of the sample and an attribute value that is among attribute values of the sample and that corresponds to the distinctive attribute category (Step S102). After that, the generator 144 sends the generated distinction information to the user terminal 2 (Step S94), and terminates the distinction information provision process.

As described above, according to this embodiment, the system controller 14 retrieves, from the storage unit 12, display logs of attribute values of each item included in first search results. Based on the retrieved logs, the system controller 14 identifies an attribute category that is among a plurality of attribute categories and that corresponds to a displayed attribute value, as a distinctive attribute category. The system controller 14 includes, in distinction information, an attribute value that is among attribute values corresponding to second comparison search results and that corresponds to the identified attribute category. Thus, the online marketplace server 1 can provide, as a distinction of the second comparison search results, an attribute value of an attribute category in which a user is likely to be interested.

### 9. Ninth Embodiment

### 9-1. Functional Overview of System Controller

The following describes a ninth embodiment. In this embodiment, the generator 144 identifies the attribute categories corresponding to displayed attribute values, based on display logs of attribute values of items based on a user's operations on first search results, as in the eighth embodiment. The generator 144 identifies an attribute category that is among the identified attribute categories and in which the variation among the displayed attribute values of a plurality of items is less than or equal to a predetermined value, as a distinctive attribute category. The generator 144 then includes, in distinction information, an attribute value that is among attribute values of second search results and that corresponds to the identified distinctive attribute category.

A user may set an attribute value range in an attribute category to search for items. Thus, an attribute category in which there is a small variation among attribute values is likely to be an attribute category in which the user is interested. On the other hand, the user is unlikely to be interested in an attribute category in which there is a large variation among attribute values. Displaying distinction information including an attribute value corresponding to a distinctive attribute category enables a user to easily see a difference between first search results and second search results, in an attribute in which the user is interested.

For example, assume that displayed prices are 10000 yen, 20000 yen, and 50000 yen. Also assume that displayed numbers of CCD pixels are 10 megapixels, 12 megapixels and 15 megapixels. The variation among the numbers of pixels is smaller than the variation among the prices. If the variation among the numbers of pixels is less than or equal to the predetermined value, the generator 144 determines “price” to be a distinctive attribute category.

### 9-2. How Information Processing System Works

The following describes an operation of the information processing system S with reference to FIG. 29. FIG. 29 is a flowchart showing an example of the distinction information provision process in the system controller 14 of the online marketplace server 1 according to this embodiment. In FIG. 29, the same steps as in FIG. 27 are denoted by the same reference signs. As shown in FIG. 29, Steps S81 to S92 are performed. Subsequently, the generator 144 identifies the attribute categories corresponding to displayed attribute values, based on display logs of attribute values of items corresponding to the first search results, among the operation logs retrieved in Step S83 (Step S111). The attribute categories are identified in the same manner as in Step S101 shown in FIG. 28. Next, based on the operation logs, the generator 144 obtains displayed attribute values from item information about items corresponding to displayed item pages. The generator 144 then calculates, for each of the identified attribute categories, the variance of the displayed attribute values (Step S112). Subsequently, the generator 144 identifies an attribute category that is among the identified attribute categories and in which the calculated variance is less than or equal to a predetermined value, as a distinctive attribute category (Step S113). Next, the generator 144 generates distinction information including both the item name of the sample and an attribute value that is among attribute values of the sample and that corresponds to the distinctive attribute category (Step S114). After that, the generator 144 sends the generated distinction information to the user terminal 2 (Step S94), and terminates the distinction information provision process.

As described above, according to this embodiment, the system controller 14 retrieves, from the storage unit 12, display logs of attribute values of each item included in first search results. Based on the retrieved logs, the system controller 14 identifies attribute categories that are among a plurality of attribute categories and that correspond to displayed attribute values. The system controller 14 determines an attribute category that is among the identified attribute categories and in which the variation among the displayed attribute values of a plurality of items is less than or equal to a predetermined value, to be a distinctive attribute category. The system controller 14 includes, in distinction information, an attribute value that is among attribute values corresponding to second comparison search results and that corresponds to the identified attribute category. Thus, the online marketplace server 1 can more correctly identify an attribute category in which a user is likely to be interested.

### REFERENCE SIGNS LIST

1 online marketplace server
2 user terminal
11 communication unit
12 storage unit
12a member DB
12b item DB
12c related search criteria DB
12d search history DB
12e operation history DB
13 input/output interface
14 system controller
14a CPU
14b ROM
14c RAM
15 system bus
141 given search criteria obtainer
142 related search criteria retriever
143 search unit
144 generator
145 provider
146 selection criteria identification unit
NW network
S information processing system

1. A computer architecture comprising:
at least one memory configured to store computer program code;
at least one processor configured to access said at least one memory and operate as instructed by said computer program code, said computer program code including:
given search criteria obtaining code configured to cause at least one of said at least one processor to obtain given search criteria given by a user;
related search criteria retrieval code configured to cause at least one of said at least one processor to retrieve, as related search criteria, search criteria related to the obtained given search criteria, from a search criteria history storage that stores a history of search criteria previously specified by the user;
first search results retrieval code configured to cause at least one of said at least one processor to retrieve first search results including search objects matching the retrieved related search criteria, from a search object storage that stores search objects;
second search results retrieval code configured to cause at least one of said at least one processor to retrieve second search results including search objects matching the obtained given search criteria, from the search object storage;
operation log retrieval code configured to cause at least one of said at least one processor to retrieve operation logs corresponding to the retrieved related search criteria, from an operation history storage that stores search criteria previously specified by the user and operation logs on search objects included in search results retrieved based on the previously specified search criteria in association with each other;
selection criteria identifying code configured to cause at least one of said at least one processor to identify selection criteria based on the retrieved operation logs;
generating code configured to cause at least one of said at least one processor to generate, based on a comparison between third search results and fourth search results, distinction information indicating a distinction of the fourth search results, the third search results being among the retrieved first search results and identified based on the retrieved operation logs, the fourth search results being among the retrieved second search results and matching the identified selection criteria; and
providing code configured to cause at least one of said at least one processor to provide the generated distinction information.

2. The computer architecture according to claim 1, wherein
the search object storage stores, for each of the search objects, a plurality of attribute values associated one-to-one with a plurality of attribute categories,
the operation log retrieval code is configured to cause at least one of said at least one processor to retrieve display logs of attribute values of each of the search objects included in the first search results,
the computer architecture further comprises display attribute category identifying code configured to cause at least one of said at least one processor to identify one or more attribute categories that are among the plurality of attribute categories and that correspond to one or more displayed attribute values, based on the retrieved display logs, and
the generating code is configured to cause at least one of said at least one processor to generate, in the distinction information, one or more attribute values that are among attribute values corresponding to the fourth search results and that correspond to the identified one or more attribute categories.

3. The computer architecture according to claim 2, wherein
the generating code is configured to cause at least one of said at least one processor to generate an attribute category that is among the identified one or more attribute categories and in which a variation among displayed attribute values of a plurality of search objects is less than or equal to a predetermined value, to be an attribute category of an attribute value included in the distinction information.

4. The computer architecture according to claim 1, wherein
the search object storage stores, for each of the search objects, a plurality of attribute values associated one-to-one with a plurality of attribute categories,
the computer architecture further comprises criteria attribute category identifying code configured to cause at least one of said at least one processor to identify, if it is determined based on attribute values stored in the search object storage that the given search criteria correspond to at least one attribute category of the plurality of attribute categories, the at least one attribute category, and
the generating code is configured to cause at least one of said at least one processor to generate, in the distinction information, an attribute value that is among attribute values corresponding to the fourth search results and that corresponds to the identified attribute category.

5. The computer architecture according to claim 1, wherein
the first search results retrieval code is configured to cause at least one of said at least one processor to retrieve the first search results from which a display rank of each of search results included in the first search results can be identified,
the second search results retrieval code is configured to cause at least one of said at least one processor to retrieve the second search results from which a display rank of each of search results included in the second search results can be identified,
the computer architecture further comprises rank identifying code configured to cause at least one of said at least one processor to retrieve, from the operation history storage, user's operation logs on search results retrieved from the search object storage based on search criteria previously specified by the user, and for identifying display ranks of search results to be viewed by the user, based on the retrieved operation logs, and
the generating code is configured to cause at least one of said at least one processor to generate the distinction information based on a comparison between search results having the identified display ranks among the third search results, and search results having the identified display ranks among the fourth search results.

6. The computer architecture according to claim 1, further comprising
first relationship obtaining code configured to cause at least one of said at least one processor to obtain a first relationship of each search result included among the first search results to the retrieved related search criteria; and
second relationship obtaining code configured to cause at least one of said at least one processor to obtain a second relationship of each search result included among the second search results to the obtained given search criteria,
wherein the generating code is configured to cause at least one of said at least one processor to generate the distinction information indicating a distinction of a fifth search result that is included among both the third and fourth search results, and
a second relationship obtained for the fifth search result is higher than a first relationship obtained for the fifth search result.

7. The computer architecture according to claim 1, wherein
the search object storage stores, for each of the search objects, a plurality of attribute values associated one-to-one with a plurality of attribute categories,
the computer architecture further comprises attribute category identifying code configured to cause at least one of said at least one processor to identify an attribute category that is among the plurality of attribute categories and in which a difference between an attribute value of search results included among the third search results and an attribute value of search results included among the fourth search results satisfies a predetermined condition, and
the generating code configured to cause at least one of said at least one processor to generate, in the distinction information, an attribute value that is among attribute values included in the fourth search results and that corresponds to the identified attribute category.

8. An information processing method performed by a computer, the method comprising:
obtaining given search criteria given by a user;
retrieving, as related search criteria, search criteria related to the obtained given search criteria, from a search criteria history storage that stores a history of search criteria previously specified by the user;
retrieving first search results including search objects matching the retrieved related search criteria, from a search object storage that stores search objects;
retrieving second search results including search objects matching the obtained given search criteria, from the search object storage;
retrieving operation logs corresponding to the retrieved related search criteria, from an operation history storage that stores search criteria previously specified by the user and operation logs on search objects included in search results retrieved based on the previously specified search criteria in association with each other;
identifying selection criteria based on the retrieved operation logs;
generating, based on a comparison between third search results and fourth search results, distinction information indicating a distinction of the fourth search results, the third search results being among the retrieved first search results and identified based on the retrieved operation logs, the fourth search results being among the retrieved second search results and matching the identified selection criteria; and
providing the generated distinction information.

9. A non-transitory computer readable medium storing thereon an information processing program, the information processing program causing a computer to obtain given search criteria given by a user;
retrieve, as related search criteria, search criteria related to the obtained given search criteria, from a search criteria history storage that stores a history of search criteria previously specified by the user;
retrieve first search results including search objects matching the retrieved related search criteria, from a search object storage that stores search objects;
retrieve second search results including search objects matching the obtained given search criteria, from the search object storage;
retrieve operation logs corresponding to the retrieved related search criteria, from an operation history storage that stores search criteria previously specified by the user and operation logs on search objects included in search results retrieved based on the previously specified search criteria in association with each other;
identify selection criteria based on the retrieved operation logs;
generate, based on a comparison between third search results and fourth search results, distinction information indicating a distinction of the fourth search results, the third search results being among the retrieved first search results and identified based on the retrieved operation logs, the fourth search results being among the retrieved second search results and matching the identified selection criteria; and
provide the generated distinction information.
